(19) United States
(12) Patent Application Publication
(10) Pub. No.: US 2025/0260001 A1
(43) Pub. Date: Aug. 14, 2025

(54) CATHODE COMPOSITIONS WITH BLENDS OF INTERCALATION MATERIALS FOR USE IN A LITHIUM SULFUR BATTERY

(71) Applicant: Conamix Inc., lthaca, NY (US)

(72) Inventors: Stephen Burkhardt, lthaca, NY (US); Jay J. Farmer, lthaca, NY (US)

(21) Appl. No.: 18/856,421

(22) PCT Filed: Apr. 14, 2023
(86) PCT No.: PCT/US2023/018609

§ 371 Date: Oct. 11, 2024

Related U.S. Application Data
(60) Provisional application No. 63/331,507, filed on Apr. 15, 2022.

(51) Int. Cl. H01M 4/36; H01M 4/02; H01M 4/136; H01M 4/38; H01M 4/58; H01M 10/052; H01M 10/0562; H01M 10/44

(52) U.S. Cl. CPC H01M 4/366; H01M 4/136; H01M 4/382; H01M 4/5815; H01M 10/052; H01M 10/0562; H01M 10/44; H01M 2004/021; H01M 2004/027; H01M 2004/028

(57) ABSTRACT

Exemplary cathode materials include a mixture of an electroactive sulfur material (e.g., S₈) and a blended non-sulfur electroactive material comprising two or more non-sulfur electroactive materials, wherein the blended non-sulfur electroactive material is selected such that a discharge voltage profile of the blend of intercalation materials—considered apart from the sulfur electroactive material—has a discharge voltage profile that has substantial overlap with the discharge voltage profile of the sulfur electroactive material. For example, in typical ether electrolytes commonly used in sulfur batteries the discharge voltage profile of S8- [symbol] Li₂S conversion has multiple plateaus (e.g., two plateaus) due to the multistep conversion of sulfur to soluble/intermediate polysulfides (PS) followed by progression to solid or quasi-solid products (e.g., Li₂S₂/Li₂S). By matching this discharge profile with a provided blend of non-sulfur electroactive materials, the rate and efficiency characteristics of the sulfur cathode can be improved throughout the battery discharge process.

### CROSS-REFERENCE TO RELATED APPLICATIONS

This application claims priority to and the benefit of U.S. Provisional Patent Application No. 63/331,507, filed Apr. 15, 2022, the contents of which are hereby incorporated by reference herein in their entirety.

### BACKGROUND

There is significant work being conducted to develop lithium ion batteries with high energy density, long cycle life, and low cost, particularly batteries for electric vehicles and consumer electronics.

Sulfur is a low cost, high specific energy material that is available as a by-product of the oil and gas industry. Sulfur's use in lithium battery cathodes has been under development for some time, but has yet to achieve wide commercial adoption. The use of sulfur can eliminate the need for cobalt and nickel in lithium batteries. Cobalt is expensive, toxic, and its mining in certain regions may be subject to loose regulation and unethical practices. Nickel has high energy density, but there are long term nickel supply concerns, for example, recently motivating Tesla's shift away from nickel-containing battery cells.

Producing sulfur cathodes capable of commercial performance levels has been a challenge, for example, because sulfur by-products reduce performance and limit cycle-life, and because low density single function materials negatively impact energy and power. There remains a need for lithium ion batteries with improved energy density, longer cycle life, and lower cost.

Additional challenges for sulfur cathodes arise from the complexities of sulfur conversion chemistry. The transformation of sulfur (e.g., S₈) to lithium sulfide (e.g., Li₂S) is a complex multistep process involving numerous intermediate species with varying chemical properties and solubilities. This complexity makes it challenging for sulfur cathodes to achieve high discharge or charge rates due to the kinetic limitations of the multi-step chemical conversion and leads to changes in performance and efficiency as a function of a battery's state of charge. Both of these features present challenges in demanding applications such as the consumer automotive market.

### SUMMARY

The present disclosure provides, among other things, cathode materials and batteries that include the same. A cathode material may include at least one electroactive sulfur material and two or more non-sulfur active materials (e.g., a blend of the two or more non-sulfur active materials).

In some aspects, the present disclosure is directed to a cathode material comprising a mixture of a first active material comprising at least one electroactive sulfur material and a second non-sulfur active material comprising a blend of two or more non-sulfur electroactive materials (e.g., metal chalcogenides, transition metal oxides, and/or polyanion compounds). Said blend may be selected such that a discharge voltage profile of the blend has voltage plateaus that approximate a discharge voltage profile of the at least one electroactive sulfur material. In some embodiments, the cathode material is at least 10 mass % non-sulfur electroactive material (e.g., metal chalcogenide) relative to sulfur, for example from 10 to 90 mass % non-sulfur electroactive material, e.g., from 30 to 70 mass % non-sulfur electroactive material.

In some embodiments, the voltage profiles of the first active material and the second active material are measured in isolation under similar electrochemical conditions to assess whether they approximate each other.

In some embodiments, the blend of two or more non-sulfur electroactive materials have a discharge voltage profile characterized in that, for at least 50% of total discharge (e.g., for at least 60%, for at least 75%, or for at least 80% of total discharge), the discharge voltage attributable to the blended non-sulfur material is within 10% (e.g., within 5%, within 3%, or within 1%) of the sulfur discharge voltage attributable to the at least one electroactive sulfur material.

In some embodiments, the at least one electroactive sulfur material comprises at least one of (i) to (iv) as follows: (i) sulfur in its S₈ cyclic octatomic molecular form, (ii) sulfur in the form of lithium sulfide (e.g., Li₂S₂ and/or Li₂S), (iii) sulfur in the form of an electroactive organosulfur compound, and (iv) sulfur in the form of an electroactive sulfur-containing polymer.

In some embodiments, each of the two or more non-sulfur electroactive materials (e.g., intercalation materials) has an individual discharge voltage profile with a voltage plateau that is distinct from a voltage plateau of an individual discharge voltage profile of any other of the two or more non-sulfur electroactive materials. In some embodiments, the blend of two or more non-sulfur electroactive materials comprises one or more chalcogenides (e.g., wherein each of the two or more non-sulfur electroactive materials is a chalcogenide) (e.g., comprising one or more metal chalcogenides, e.g., one or more metal sulfides). In some embodiments, each of the two or more non-sulfur electroactive materials (i) has a different crystal structure (e.g., layered, spinel, olivine, tavorite), (ii) has a different composition, or (iii) both (i) and (ii).

In some embodiments, the second non-sulfur active material has a discharge voltage profile with two plateaus. In some embodiments, one of the two plateaus corresponds to soluble/intermediate polysulfide conversion and another of the two plateaus corresponds to solid or quasi-solid product(s). In some embodiments, the second non-sulfur active material has a discharge voltage profile that approximates a discharge voltage profile of sulfur to a lithium sulfide (e.g., S₈→Li₂S). In some embodiments, the discharge voltage profile with two plateaus has a first plateau in a range from about 2.2 to about 2.4 (V vs. Li/Li⁺), and a second plateau in a range from about 2.0 to about 2.2 (V vs. Li/Li⁺).

In some embodiments, the at least one electroactive sulfur material has a discharge voltage profile with two plateaus. In some embodiments, one of the two plateaus corresponds to soluble/intermediate polysulfide conversion and another of the two plateaus corresponds to solid or quasi-solid product(s). In some embodiments, the second non-sulfur active material has a discharge voltage profile that approximates a discharge voltage profile of sulfur to a lithium sulfide (e.g., S₈→Li₂S). In some embodiments, the discharge voltage profile with two plateaus has a first plateau in a range from about 2.2 to about 2.4 (V vs. Li/Li⁺), and a second plateau in a range from about 2.0 to about 2.2 (V vs. Li/Li⁺).

In some aspects, the present disclosure is directed to a cathode material comprising: an electroactive sulfur material and two or more non-sulfur electroactive materials (e.g., a blend of the two or more non-sulfur electroactive materials). In some embodiments, the two or more electroactive materials together have a discharge voltage profile with at least two distinct voltage plateaus. The electroactive sulfur material may comprise at least one of (i) to (iv) as follows: (i) sulfur in its S₈ cyclic octatomic molecular form, (ii) sulfur in the form of lithium sulfide (e.g., Li₂S₂ and/or Li₂S), (iii) sulfur in the form of an electroactive organosulfur compound, and (iv) sulfur in the form of an electroactive sulfur-containing polymer. For example, the electroactive sulfur material may comprise at least one of (i) sulfur (S₈) and (ii) a lithium sulfide (e.g., Li₂S₂ and/or Li₂S) (e.g., both). The cathode material may comprise another electroactive sulfur material. The two or more non-sulfur electroactive materials may be intercalation materials (e.g., lithium-intercalation materials).

In some embodiments, the two or more non-sulfur electroactive materials together have a discharge voltage profile that corresponds to a discharge voltage profile for sulfur (e.g., each of the two or more electroactive materials having a discharge voltage profile with a voltage plateau that corresponds to a voltage plateau of the discharge voltage profile for sulfur). In some embodiments, each of the two or more non-sulfur electroactive materials has an individual discharge voltage profile with a voltage plateau that is distinct from a voltage plateau of an individual discharge voltage profile of any other of the two or more non-sulfur electroactive materials. In some embodiments, the voltage plateau of the individual discharge voltage profile of each of the two or more electroactive materials is within 10% (e.g., within 5%, within 3%, or within 1%) of a corresponding voltage plateau of the discharge voltage profile for sulfur.

In some embodiments, the cathode material comprises core shell structures. In some embodiments, the core shell structure comprise cores each having a surrounding shell, said cores comprising the electroactive sulfur material (e.g., S₈, Li₂S₂ and/or Li₂S), and said shells comprising at least one of the two or more non-sulfur electroactive materials (e.g., one or more metal chalcogenides). In some embodiments, the core shell structures have an average core diameter in a range from 50 to 300 nm, and an average shell thickness in a range from 1 to 20 nm thick (e.g., no greater than 10 nm thick). In some embodiments, the core shell structures have at least 10 mass % non-sulfur electroactive material (e.g., metal chalcogenide) relative to sulfur (e.g., from 10 to 90 mass % non-sulfur, non-carbon electroactive material, e.g., from 30 to 70 mass % non-sulfur, non-carbon electroactive material).

In some embodiments, a battery (e.g., a secondary battery) comprises (i) a cathode comprising a cathode material disclosed herein (e.g., in the summary section) and (ii) an electrolyte (e.g., a solid-state electrolyte (SSE)) in contact with the cathode. In some embodiments, the battery further comprises an anode. In some embodiments, the anode is a protected lithium metal anode. In some embodiments, the battery further comprises a protected current collector.

In some aspects, the present disclosure is directed to a method of operating a lithium-sulfur battery. The lithium-sulfur battery may include a cathode comprising (i) sulfur or a lithium sulfide (e.g., Li₂S₂ and/or Li₂S) (e.g., both sulfur and a lithium sulfide), (ii) a first non-sulfur electroactive material (e.g., first intercalation material), and (iii) a second non-sulfur electroactive material (e.g., a second intercalation material) different from the first non-sulfur electroactive material. The method may include discharging the battery. Discharging the battery may include simultaneously inserting (e.g., intercalating) lithium into the first non-sulfur electroactive material while at least partially converting at least a portion of the sulfur or a lithium sulfide (e.g., from S₈→Li₂S) at a first voltage. Discharging the battery may further include subsequently simultaneously inserting (e.g., intercalating) lithium into the second non-sulfur electroactive material while at least partially (e.g., further) converting at least a portion the sulfur of a lithium sulfide (e.g., from S₈→Li₂S) at a second voltage different from the first voltage. A battery may be completed discharged by completed both of the simultaneous insertion steps.

In some embodiments, the method comprises charging the battery after discharging the battery. Charging the battery may include simultaneously (i) removing lithium from the first non-sulfur electroactive material, (ii) removing lithium from the second non-sulfur electroactive material, and (iii) at least partially converting at least a portion of the sulfur or a lithium sulfide (e.g., from Li₂S→S₈) at a third voltage (e.g., different from the first voltage and from the second voltage).

In some aspects, the present disclosure is directed to a method of operating a battery. The battery may include a cathode comprising (i) a sulfur electroactive material, (ii) a first non-sulfur electroactive material (e.g., first intercalation material), and (iii) a second non-sulfur electroactive material (e.g., a second intercalation material) different from the first non-sulfur electroactive material. The method may include discharging the battery. Discharging the battery may include simultaneously inserting (e.g., intercalating) an ion (e.g., lithium) into the first non-sulfur electroactive material while at least partially converting at least a portion of the sulfur electroactive material at a first voltage. Discharging the battery may further include subsequently simultaneously inserting (e.g., intercalating) an ion (e.g., lithium) into the second non-sulfur electroactive material while at least partially (e.g., further) converting at least a portion the sulfur electroactive material [e.g., of a lithium sulfide (e.g., from S₈→Li₂S)] at a second voltage different from the first voltage. A battery may be completed discharged by completed both of the simultaneous insertion steps.

In some embodiments, the method comprises charging the battery after discharging the battery. Charging the battery may include simultaneously (i) removing the ion from the first non-sulfur electroactive material, (ii) removing the from the second non-sulfur electroactive material, and (iii) at least partially converting at least a portion of the sulfur electroactive material [e.g., the sulfur or lithium sulfide (e.g., from Li₂S→S₈)] at a third voltage (e.g., different from the first voltage and from the second voltage).

In some aspects, the present disclosure is directed to a cathode material comprising at least one electroactive sulfur material, for example comprising at least one of (i) sulfur (S8) and (ii) a lithium sulfide (e.g., Li2S2 and/or Li2S), and two or more intercalation materials (e.g., lithium-intercalation materials). In some embodiments, each of the two or more intercalation materials has an individual discharge voltage profile with a voltage plateau that is distinct from a voltage plateau of an individual discharge voltage profile of any other of the two or more intercalation materials. In some embodiments, a blended discharge voltage profile approximates a discharge voltage profile for the at least one electroactive sulfur material.

In some aspects, the present disclosure is directed to an solid-state sulfur battery. The battery may include an anode; a solid electrolyte; and a cathode. The cathode may include a first active material comprising at least one electroactive sulfur material. The cathode may further include one or more non-sulfur electroactive materials (e.g., metal chalcogenides, transition metal oxides, and/or polyanion compounds). In some embodiments, a discharge voltage profile of the one or more non-sulfur electroactive materials approximates at least a portion of a discharge voltage profile of the at least one electroactive sulfur material [e.g., wherein the cathode material is at least 10 mass % non-sulfur electroactive material (e.g., metal chalcogenide) relative to sulfur (e.g., from 10 to 90 mass % non-sulfur electroactive material, e.g., from 30 to 70 mass % non-sulfur electroactive material)].

In some embodiments, the one or more non-sulfur electroactive materials is a blend of two or more non-sulfur electroactive materials. In some embodiments, the at least a portion of the discharge voltage profile comprises two or more distinct portions, each corresponding to one of the two or more non-sulfur electroactive materials.

In some embodiments, the one or more non-sulfur electroactive materials comprises (e.g., is) a mixed metal sulfide.

In some embodiments, the at least a portion of the discharge voltage profile exists in a voltage range of 2.5 V to 1.9 V (e.g., 2.3 V to 2.1 V) and/or a SoC range of 90% to 30% (e.g., 90% to 60%). In some embodiments, the at least a portion of the discharge voltage profile is a sloping (e.g., moderately and/or monotonically sloping) portion of the discharge voltage profile.

In some aspects, the present disclosure is directed to a cathode material comprising a mixture of at least one electroactive sulfur material; and at least one non-sulfur electroactive material that is a mixed metal chalcogenide, wherein a discharge voltage profile of the at least one non-sulfur electroactive material corresponds to a discharge voltage profile of the at least one electroactive sulfur material.

In some embodiments, the at least one non-sulfur electroactive material comprises two non-sulfur electroactive materials (two mixed metal chalcogenides). In some embodiments, the at least one non-sulfur electroactive material is a single non-sulfur electroactive material (a single mixed metal chalcogenides).

In some embodiments, the mixed metal chalcogenide is a mixed metal sulfide (e.g., wherein the mixed metal chalcogenides are mixed metal sulfides where the at least one non-sulfur electroactive material comprises two non-sulfur electroactive materials).

In some embodiments, the discharge voltage profile of the at least one non-sulfur electroactive material has voltage plateaus that approximate voltage plateaus of the at least one electroactive sulfur material. In some embodiments, the at least one non-sulfur electroactive material has a discharge voltage profile characterized in that, for at least 50% of total discharge (e.g., for at least 60%, for at least 75%, or for at least 80% of total discharge), the discharge voltage attributable to the at least one non-sulfur material is within 10% (e.g., within 5%, within 3%, or within 1%) of the sulfur discharge voltage attributable to the at least one electroactive sulfur material.

In some embodiments, the at least one electroactive sulfur material comprises at least one of (i) to (iv) as follows: (i) sulfur in its S₈ cyclic octatomic molecular form, (ii) sulfur in the form of lithium sulfide (e.g., Li₂S₂ and/or Li₂S), (iii) sulfur in the form of an electroactive organosulfur compound, and (iv) sulfur in the form of an electroactive sulfur-containing polymer.

In some embodiments, the discharge voltage profile of the at least one non-sulfur electroactive material has two voltage plateaus with one of the two plateaus corresponding to soluble/intermediate polysulfide conversion and another of the two plateaus corresponding to solid or quasi-solid product(s). In some embodiments, the discharge voltage profile of the at least one non-sulfur electroactive material has two voltage plateaus with a first plateau in a range from about 2.2 to about 2.4 (V vs. Li/Li⁺), and a second plateau in a range from about 2.0 to about 2.2 (V vs. Li/Li⁺). In some embodiments, the at least one non-sulfur electroactive material has a discharge voltage profile that approximates a discharge voltage profile of sulfur to a lithium sulfide (e.g., S₈→Li₂S).

In some embodiments, the cathode material is at least 10 mass % non-sulfur electroactive material (e.g., mixed metal chalcogenide) relative to sulfur (e.g., from 10 to 90 mass % non-sulfur electroactive material, e.g., from 30 to 70 mass % non-sulfur electroactive material).

A battery may include (i) a cathode comprising the cathode material and (ii) an electrolyte (e.g., a solid-state electrolyte (SSE)) in contact with the cathode. In some embodiments, the battery further includes an anode. In some embodiments, the anode is a protected lithium metal anode. In some embodiments, the battery further includes a protected current collector.

A cathode material disclosed herein may be included in a cathode. The cathode may be in an electrochemical cell. The electrochemical cell may be a battery. The battery may be a primary battery, a low-cycle life battery, or a secondary battery. The battery may be, for example, a sulfur battery, such as a lithium-sulfur battery.

Any two or more of the features described in this specification, including in this summary section, may be combined to form implementations of the disclosure, whether specifically expressly described as a separate combination in this specification or not.

### BRIEF DESCRIPTION OF THE DRAWING

The present teachings described herein will be more fully understood from the following description of various illustrative embodiments, when read together with the accompanying drawings. It should be understood that the drawing described below is for illustration purposes only and is not intended to limit the scope of the present teachings in any way. The foregoing and other objects, aspects, features, and advantages of the disclosure will become more apparent and may be better understood by referring to the following description taken in conjunction with the accompanying drawings, in which:

FIG. 1 is a schematic diagram illustrating an exemplary discharge profile of a lithium sulfur battery operating with a liquid electrolyte;

FIG. 2 is a pictorial representation of a cross-section of an electrochemical cell according to certain embodiments of the disclosure; and

FIG. 3 is a pictorial representation of a cylindrical battery embodying concepts of the disclosure.

### DEFINITIONS

About/Approximately: The term “about” or “approximately”, when used herein in reference to a value, refers to a value that is similar, in context, to the referenced value. In general, those skilled in the art, familiar with the context, will appreciate the relevant degree of variance encompassed by “about” or “approximately” in that context. For example, in some embodiments, e.g., as set forth herein, the term “about” can encompass a range of values that within 25%, 20%, 19%, 18%, 17%, 16%, 15%, 14%, 13%, 12%, 11%, 10%, 9%, 8%, 7%, 6%, 5%, 4%, 3%, 2%, 1%, or within a fraction of a percent, of the referred value.

Intercalation Material: As used herein, the term “intercalation material” refers to a substance into which another substance or species (e.g., ion, metal ion) is reversibly inserted or included in vacancies, interstitial sites, voids, or between layers of the intercalation material, or some combination thereof.

Electroactive Material: As used herein, the term “electroactive material” refers to a composition of matter with one or more components capable of changing its oxidation state in a charge-transfer step of an electrochemical reaction.

Lithium alloy: As used herein, the term lithium alloy refers to substances formed by combinations of lithium and other metals or semimetal elements: non-limiting examples include lithium silicon compounds, and alloys of lithium with metals such as sodium, cesium, indium, aluminum, zinc and silver.

Nanoparticle, Nanostructure, Nanomaterial: As used herein, these terms may be used interchangeably to denote a particle of nanoscale dimensions or a material having nanoscale structures. The nanoparticles can have essentially any shape or configuration, such as a tube, a wire, a laminate, sheets, lattices, a box, a core and shell, or combinations thereof.

Substantially: As used herein, the term “substantially” refers to the qualitative condition of exhibiting total or near-total extent or degree of a characteristic or property of interest.

### DETAILED DESCRIPTION OF CERTAIN EMBODIMENTS

The present disclosure seeks among other things, to improve the rate capability and state of charge (SoC)-dependent performance characteristics that have heretofore limited the commercial application of lithium sulfur batteries. Presented herein is a cathode for a lithium sulfur battery, said cathode comprising a mixture of i) electroactive sulfur (e.g., S₈) and ii) a blended electroactive material comprising two or more non-sulfur electroactive materials, wherein the blended non-sulfur electroactive material is selected such that a discharge voltage profile of the blend of intercalation materials—considered apart from the sulfur electroactive material—has a discharge voltage profile that has substantial overlap with the discharge voltage profile of the sulfur electroactive material. For example, in typical ether electrolytes commonly used in sulfur batteries the discharge voltage profile of S₈→Li₂S conversion has multiple plateaus (e.g., two plateaus) due to the multistep conversion of sulfur to soluble/intermediate polysulfides (PS) followed by progression to solid or quasi-solid products (e.g., Li₂S₂/Li₂S).

By matching this discharge profile with a provided blend of non-sulfur electroactive materials, one or more rate and efficiency characteristics of a sulfur cathode can be improved, for example throughout a battery discharge process. For example, while not wishing to be bound by any particular theory, intercalation compounds may provide solid state ion transport pathways into an electrode (e.g., cathode) by percolation through intercalation material particles. Under conditions where solid end-products of sulfur charge/discharge are clogging a pore structure of the electrode (e.g., cathode), intercalation materials may provide an alternative pathway for ion transport. Additionally, resistance of an electrolyte and kinetics of sulfur electrochemical conversion vary with the state of charge of the electrode (e.g., cathode). Such alternate pathways may allow an electrode (e.g., cathode), for example in an electrochemical cell (e.g., battery) to equilibrate faster and/or achieve higher power. The present disclosure provides electrodes that include intercalation materials to provide voltage support under high power pulses across the state of charge of a device (e.g., battery), thereby improving the efficiency of pulse power (e.g., less heat generation and more useable energy from the pulse). Data show that intercalation materials included in an electrode (e.g., cathode) that includes a sulfur electroactive material can alter (e.g., improve) rate capability of the electrode at different states of charge (e.g., both high and low states of charge), for example without substantially altering the discharge voltage profile of the electrode as compared to an otherwise equivalent electrode without the intercalation materials. When the high power load on the cell is released, intercalation materials can then discharge into the sulfur material, and the intercalation materials are regenerated for follow-up high load situations. Lower heat generation has system-level benefits, in some embodiments allowing for reduced thermal management infrastructure in a battery pack and necessitating fewer cells to produce the same power.

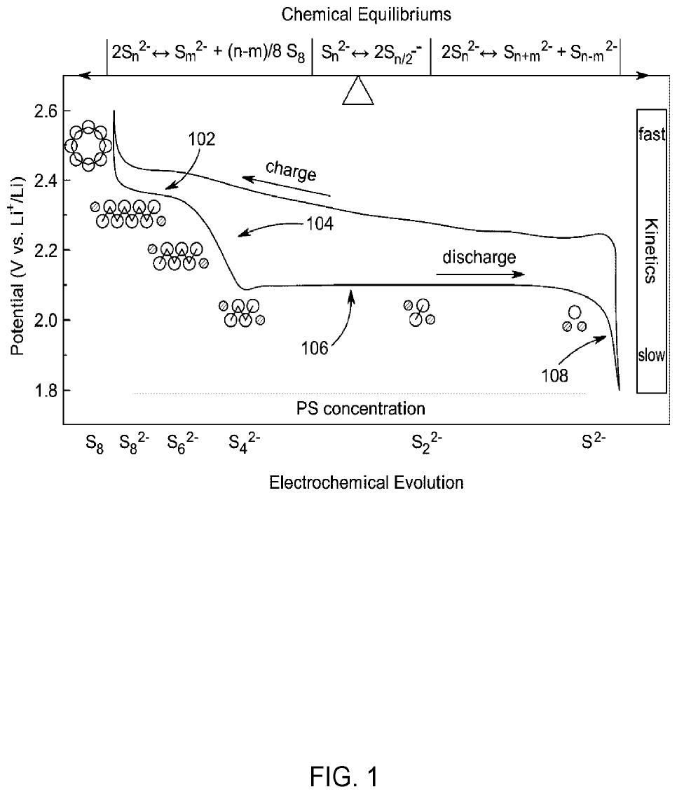

FIG. 1 is a schematic diagram illustrating a typical discharge profile of a lithium sulfur battery operating with a liquid electrolyte. The discharge (the lower red curve) shows two plateaus, beginning with a plateau at ˜2.37V believed to correspond to the conversion of S₈ to soluble Li₂S₈, followed by a second plateau at ˜2.1V believed to correspond to reduction of polysulfide (PS) from high-order to low-order polysulfides (S₈²⁻→S₆²⁻→S₄²⁻), then followed by the deposition of Li₂S₂/Li₂S as solid or quasi-solid products. Cell charging follows a reverse PS evolution, as illustrated in the upper blue curve.

Intercalation is the process by which a mobile ion or molecule is reversibly incorporated into vacant sites in a crystal lattice of a host network. Intercalation minimizes volume change and mechanical strain during repeated insertion and extraction of ions during charge and discharge. An intercalation cathode comprises a solid host network which can store guest ions that are inserted into and removed from the host network reversibly.

Presented herein is a technique for using a blend of intercalation active materials (e.g., non-sulfur intercalation materials) and/or non-sulfur conversion active materials designed such that the discharge voltage profile of the blend tracks the discharge profile of an electroactive sulfur material under like conditions. In certain embodiments, the blend of two or more intercalation materials is combined with an electroactive sulfur composition (e.g., for example, sulfur in its S₈ cyclic octatomic molecular form, in the form of lithium sulfide (e.g., Li₂S₂ and/or Li₂S), and/or in the form of an electroactive organosulfur compound or an electroactive sulfur containing polymer). The blend is chosen such that its discharge voltage profile—considered apart from the electroactive sulfur composition—has voltage plateaus that approximate those of the discharge voltage profile of S₈→Li₂S. For example, the blend of intercalation materials has a discharge voltage profile in liquid electrolyte featuring two plateaus at approximately the same voltages the two plateaus of the discharge voltage profile shown in FIG. 1 [e.g., a first plateau with potential vs. Li/L⁺ in a range from about 2.2 to about 2.4V, and a second plateau (distinct from the first) with potential vs. Li/L⁺ in a range from about 2.0 to about 2.2V, e.g., when compared using the same electrolyte since electrolyte composition may affect the discharge voltage profile]. In certain embodiments, the distribution of the discharge capacity of the blended intercalation across its multiple discharge voltage plateau approximates the ratio of capacity observed in the discharge plateaus of sulfur conversion.

One or more non-sulfur electroactive materials may be added to a battery (e.g., a lithium sulfur battery) (e.g., at the cathode) to provide additional capacity to a battery. By providing a blend of electroactive materials that each have a discharge voltage profile that substantially overlaps with a feature in the discharge profile of the electroactive sulfur in the battery to which they are added (i.e., absent the blended electroactive materials), additional capacity and/or rate capability can be added to the battery. For example, the blended non-sulfur electroactive materials can feature a discharge voltage profile characterized in that, for at least 50% of total discharge (e.g., of the battery) (e.g., for at least 60%, for at least 75%, or for at least 80% of total discharge (e.g., of the battery)), the discharge voltage attributable to the blended material is within 10% (e.g., within 5%, within 3%, or within 1%) of the sulfur discharge voltage attributable to the sulfur electroactive material. Individual discharge voltage profiles of non-sulfur electroactive materials are available in the literature and/or may be obtained experimentally. Discharge voltage profiles of combinations (e.g., blends) of two or more non-sulfur electroactive materials may be obtained experimentally or estimated, for example through simulation.

A lithium sulfur battery operates by converting between electroactive sulfur and lithium metal in the charged state to lithium sulfide in the discharged state. In certain lithium sulfur battery systems, this process is characterized by two distinct voltage plateaus during discharge. In certain embodiments, a provided blended non-sulfur electroactive material may have a discharge voltage profile featuring voltage plateaus that substantially overlap with the voltage plateaus in the discharge voltage profile of the sulfur electroactive material with which the blend is to be combined. For example, with reference to FIG. 1, one electroactive material in the non-sulfur blend may have a voltage plateau that corresponds to the about 2.2-2.4V plateau and another electroactive material in the blend may have a voltage plateau that corresponds to the about 2.0-2.2V plateau (though the exact values may be shifted somewhat for different electrochemical environments (e.g., electrolytes)).

A region of a discharge profile of a provided cathode (e.g., in a battery) where the discharge voltage is relatively constant when the discharge current is held constant is a voltage plateau. The term plateau does not necessarily suggest there is no change at all in discharge potential, but rather that the rate of change in discharge voltage as a function of the state of charge (SoC) is small in a particular region relative to other parts of the cathode's (e.g., battery's) discharge profile. By way of illustration, FIG. 1 shows an exemplary discharge voltage profile of a typical lithium sulfur battery discharged at a constant current. Inspection of this discharge profile reveals at least four distinct regions: an initial region 102 where the battery has a relatively constant discharge voltage of about 2.35 volts, a second region 104 where the discharge voltage has a steeper slope falling rapidly from about 2.35 volts to 2.1 volts, followed by a third region 106 again showing relatively constant discharge voltage around 2.1 volts followed finally by region 108 again characterized by a steep decline in discharge voltage near the end of discharge. In systems of this type, the term plateau has the common meaning and refers to regions such as 102 and 106 where the slope of the voltage vs. total discharge (or time in the case of a constant current discharge) is low relative to adjacent regions of steeper slope.

A discharge voltage profile for a battery may or may not have one or more voltage plateaus. For example, in some embodiments, a solid-state sulfur battery has a discharge voltage profile with at least a portion that is monotonically sloping. The monotonically sloping portion may be relatively long and moderately sloping. Whether or not there is a voltage plateau in such a discharge voltage profile, one or more intercalation materials may be selected that approximate at least a portion of a discharge profile of a battery, such as a solid-state battery (e.g., a solid-state sulfur battery). In some embodiments, a blend of two or more non-sulfur electroactive materials (e.g., intercalation materials) may be included in a cathode material where each said material approximates at least a portion of the discharge voltage profile (e.g., distinct portions). Such portion(s) of the discharge voltage profile may exist within a particular voltage range (e.g., 2.3 V to 2.1 V) and/or a particular range of SoC (e.g., between 90% and 60% SoC).

In some embodiments, a non-sulfur electroactive material (e.g., intercalation material) has a discharge voltage profile that corresponds to (e.g., approximates) a discharge voltage profile of at least one sulfur electroactive material. For example, in some embodiments, a non-sulfur electroactive material has a discharge voltage that corresponds to a voltage plateau in a discharge voltage profile of at least on sulfur electroactive material or has a discharge voltage profile with a voltage plateau that corresponds to a voltage plateau in a discharge voltage profile of at least on sulfur electroactive material. As another example, in some embodiments, a non-sulfur electroactive material has a discharge voltage profile that corresponds to (e.g., approximates) a discharge voltage profile of at least one sulfur electroactive material in that the discharge voltage of the non-sulfur electroactive material is (i) within 0.3 V (e.g., within 0.2 V, within 0.1 V, or within 0.05 V) and/or (ii) within 10% (e.g., within 5%, within 3%, or within 1%) of the discharge voltage of the at least one sulfur electroactive material over at least a portion of the discharge voltage profile of the at least one sulfur electroactive material. Such may be the case in a solid-state sulfur battery or in a liquid battery, for example. The at least a portion of the discharge voltage profile of the at least one sulfur electroactive material may be defined by a voltage range and/or an SoC range. The voltage range may be, for example, 2.5 V to 1.9 V, 2.4 V to 2.0 V, 2.3 V to 2.1 V, 2.5 V to 2.0 V, 2.5 V to 2.1 V, 2.5 V to 2.2 V, 2.4 V to 2.1 V, 2.4 V to 2.2 V, 2.3 V to 2.0 V, 2.3 V to 1.9 V, 2.2 V to 1.9 V, or 2.2 V to 2.0 V. The SoC range may be, for example, 90% to 30% SoC, 90% to 40% SoC, 90% to 50% SoC, 90% to 60% SoC, 90% to 70% SoC, 80% to 30% SoC, 80% to 40% SoC, 80% to 50% SoC, 80% to 60% SoC, 70% to 30% SoC, 70% to 40% SoC, 70% to 50% SoC, 60% to 30% SoC, or 60% to 40% SoC. In some embodiments, a portion of a discharge voltage profile of at least one sulfur electroactive material to which a discharge voltage or discharge voltage profile of a non-sulfur electroactive material corresponds to (e.g., approximates) is sloping. For example, it may be moderately sloping (e.g., as in certain solid-state sulfur batteries), monotonically sloping, or moderately monotonically sloping.

During operation of a lithium sulfur battery that includes a provided blend of two or more non-sulfur electroactive materials, each of the electroactive materials may store or release ions, and therefore charge, in addition to the ions/charge stored respectively, by the electroactive sulfur. In some embodiments, a method of operating a battery includes converting at least a portion of the electroactive sulfur while simultaneously inserting (e.g., intercalating) lithium ions into a first electroactive material at a first voltage during discharge. For example, lithium may be inserted into a first electroactive material by storing the lithium at (e.g., on) a surface of the electroactive material or in a bulk of the electroactive material (e.g., in vacancies, interstitial sites, voids, or between layers of the electroactive material, or some combination thereof) (e.g., intercalated into the electroactive material). The conversion of the electroactive sulfur at this step may occur along the pathway of S₈ to Li₂S. (The conversion may be fully completed (at least to Li₂S₂ and/or Li₂S) at complete discharge of the battery, for at least a substantial majority (e.g., at least 80%) of the initial electroactive sulfur present at full charge.) Such simultaneous conversion and insertion into the first electroactive material may occur at a first voltage plateau in a discharge voltage profile of the battery (e.g., about 2.2-2.4V, with reference to FIG. 1).

In some embodiments, a method of operating a battery further includes converting at least a portion of the electroactive sulfur while simultaneously inserting (e.g., intercalating) lithium into a second electroactive material at a second voltage, different from the first voltage, during discharge. For example, lithium may be inserted into a second electroactive material by storing the lithium at (e.g., on) a surface of the electroactive material or in a bulk of the electroactive material (e.g., in vacancies, interstitial sites, voids, or between layers of the electroactive material, or some combination thereof) (e.g., intercalated into the electroactive material). The second voltage may be lower than the first voltage. The conversion of the sulfur or lithium sulfide at this step may occur along the pathway of S₈ to Li₂S, for example later along the conversion pathway than the first step with the first electroactive material. Such simultaneous conversion and insertion into the second electroactive material may occur at a second voltage plateau in a discharge voltage profile of the battery (e.g., about 2.0-2.2V, with reference to FIG. 1). The second step with the second electroactive material may occur sequentially (e.g., after) the first step with the first electroactive material (e.g., as would be the case during charge of the battery shown in FIG. 1 if two electroactive materials were added, one for each voltage plateau).

In some embodiments, a battery incorporating multiple electroactive materials as just described can be charged by simultaneously, at a third voltage, (i) removing (e.g., de-intercalating) lithium from the first electroactive material, (ii) removing lithium from the second electroactive material, and (iii) converting at least a portion of the lithium sulfide (or lithium polysulfides) to more oxidized sulfur species (e.g., longer chain polysulfides or elemental sulfur). The conversion of the at least a portion of the lithium polysulfide or lithium sulfide may be along the pathway of Li₂S to S₈. (The conversion may be fully completed (e.g., to S₈) at complete charge of the battery, for at least a substantial majority (e.g., at least 80%) of the initial lithium sulfide present at full discharge.) The third voltage may be different from the first voltage and/or the second voltage (e.g., higher than one or both).

In certain embodiments described herein, discharge voltage profile(s) of the blended electroactive material(s) (e.g., intercalation material(s)) are compared to a discharge voltage profile of sulfur. For example, discharge voltage profile(s) of electroactive material(s) (e.g., intercalation material(s)) are described as corresponding to or approximating a discharge voltage profile of sulfur. Such comparison may be made by measuring the discharge voltage profiles of the electroactive sulfur and of the blended non-sulfur electroactive material independently in an electrochemical environment that is otherwise similar or identical. For example, the discharge voltage profile of an electroactive material may have a voltage plateau that approximates a voltage plateau of discharge voltage profile of sulfur when considering the same electrochemical environment with the exception of the substitution (or addition) of the electroactive material for (to) sulfur (e.g., same electrolyte and/or anode).

In certain embodiments, a blend of two or more intercalation materials is used in a cathode containing electroactive sulfur (e.g., sulfur in its S₈ cyclic octatomic molecular form) and/or lithium sulfide (e.g., Li₂S₂ and/or Li₂S). In certain embodiments, the blend of intercalation materials comprises two or more intercalation materials each having a discharge voltage plateau distinct from each other such that the blend has a discharge voltage profile with two or more plateaus.

In certain embodiments, the blend of two or more intercalation materials comprises one or more chalcogenides (e.g., wherein at least one of the two or more intercalation materials is a chalcogenide). In certain embodiments, a chalcogenide has at least one chalcogen anion (oxygen, sulfur, selenium, tellurium, or polonium anion) and at least one electropositive element. In certain embodiments, the one or more chalcogenides may be sulfide-, selenide-, or telluride-based. In certain embodiments, the one or more chalcogenides comprises a metal sulfide. In certain embodiments, the one or more chalcogenides comprises one or more of the following: TiS₂, LiTiS₂ (LTS), VS₂, MoS₂, Mo₂S₈, TaS₂, and NbSe₃. In certain embodiments, the one or more chalcogenides comprises a transition metal oxide and/or a polyanion compound. In certain embodiments, the one or more chalcogenides comprises a metal monochalcogenide having the formula MX where M is a transition metal and X is S, Se, or Te. In certain embodiments, the one or more chalcogenides comprises at least one transition metal dichalcogenide (TMD) of the formula MX₂, where M is a transition metal (e.g., Ti, V, Co, Ni, Zr, Nb, Mo, Tc, Rh, Pd, Hf, Ta, W, Re, Ir, or Pt) and where X is S, Se, or Te. In certain embodiments, the one or more chalcogenides comprises a material with a layered crystal structure (e.g., LiTiS₂, LiCoO₂, LiNiO₂, LiMnO₂, LiNi_{0.33}Mn_{0.33}Co_{0.33}O₂, LiNi_{0.8}Co_{0.15}Al_{0.05}O₂, or Li₂MnO₃), a material with a spinel crystal structure (e.g., LiMn₂0₄ or LiCo₂0₄), a material with an olivine crystal structure (e.g., LiFePO₄, LiMnPO₄, or LiCoPO₄), and/or a material with a tavorite crystal structure (e.g., LiFeSO₄F or LiVPO₄F).

In certain embodiments, one or more non-sulfur electroactive materials comprises a mixed metal sulfide (MMS) (e.g., rather than a physical blend of two or more pure metal sulfides). Such mixed metal sulfides contain two or more transition metals within their crystal lattices. An MMS may have a discharge voltage profile that has one or more voltage plateaus (e.g., each attributable to one of its constituent metals). A discharge voltage profile of an MMS may correspond to (e.g., approximate) a discharge voltage profile of at least one sulfur electroactive material. In certain embodiments, a non-sulfur electroactive material is an MMS of formula TiₓM_{y}S_{z}, where M is a transition metal other than titanium and x, y, and z are any value such that the MMS has a chemically stable structure. In certain embodiments, a non-sulfur electroactive material is an MMS of formula MoₓM_{y}S_{z} where M is a transition metal other than molybdenum and x, y, and z are any value such that the MMS has a chemically stable structure. In certain embodiments, a non-sulfur electroactive material is an MMS of formula VₓM_{y}S_{z} where M is a transition metal other than vanadium and x, y, and z are any value such that the MMS has a chemically stable structure. In certain embodiments, a non-sulfur electroactive material is an MMS of formula FeₓM_{y}S_{z} where M is a transition metal other than iron and x, y, and z are any value such that MMS has a chemically stable structure. In certain embodiments, a non-sulfur electroactive material is an MMS of formula TaₓM_{y}S_{z} where M is a transition metal other than tantalum and x, y, and z are any value such that MMS has a chemically stable structure. In certain embodiments, any of the foregoing MMS formulae are characterized in that 2(x+y)=z.

In certain embodiments, a non-sulfur electroactive material is an MMS containing three transition metals. In certain embodiments, the MMS has a formula TiₓM_{y}M′_{Y′}S_{z} where M and M′ are each metals other than titanium and x, y, y′ and z are any value such that the MMS has a chemically stable structure. In certain embodiments, the MMS has a formula MoₓM_{y}M′_{Y′}S_{z} where M and M′ are each metals other than molybdenum and x, y, y′ and z are any value such that the MMS has a chemically stable structure. In certain embodiments, the MMS has a formula VₓM_{y}M′_{Y′}S_{z} where M and M′ are each metals other than vanadium and x, y, y′ and z are any value such that the MMS has a chemically stable structure. In certain embodiments, the MMS has a formula FeₓM_{y}M′_{Y′}S_{z} where M and M′ are each metals other than iron and x, y, y′ and z are any value such that the MMS has a chemically stable structure. In certain embodiments any of the foregoing MMS formulae are characterized in that 2(x+y+y′)=z.

In certain embodiments, a non-sulfur electroactive material comprises a chemically stable MMS having a stoichiometry of formula MoₓTi_{y}S_{z} (e.g., Mo_{0.5}Ti_{0.5}S₂), NiₓCo_{y}S_{z} (e.g., NiₓCo₃₋ₓS₄, CoₓNi₁₋ₓS₂, Ni_{3.5}Co_{3.5}S₈, Ni₃Co₆S₈), CuₓCo_{y}S_{z} (e.g., CuCo₂S₄), ZnₓCo_{y}S_{z} (e.g., ZnₓCo₁₋ₓS), MnₓCo_{y}S_{z} (e.g., MnCo₂S₄), FeₓCo_{y}S_{z} (e.g., FeₓCo₁₋ₓS₂), NiₓFe_{y}S_{z} (e.g., NiₓFe₁₋ₓS₂, FeNiS₂, NiₓFe₃₋ₓS₄ (e.g., Ni₂FeS₄)), NiₓMo_{y}S_{z} (e.g., NiₓMo₄₋ₓS₄ (e.g., NiMo₃S₄), MₓMo₆S_{8-y} (e.g., CuₓMo₆S_{8-y}, AgₓMo₆S_{8-y}, FeₓMo₆S_{8-y}, CrₓMo₆S_{8-y}, CoₓMo₆S_{8-y}, NiₓMo₆S_{8-y}, Cu₂MoS₄), MₓSb_{y}S_{z} (where M=Cu, Co, or Bi), or MₓSn_{y}S_{z} (where M=Cu or Co). Examples of such materials, and others, that may be used as non-sulfur electroactive materials in a cathode material (e.g., in a cathode) are discussed in Yu, X. Y., and Lou, X. W., Mixed Metal Sulfides for Electrochemical Energy Storage and Conversion, Adv. Energy Mater. 8: 17015921 (2018); doi: 10.1002/aenm.201701592.

In some embodiments, a mixed metal chalcogenide (MMC) is used as a non-sulfur electroactive material. The chalcogen in an MMC may be oxygen, sulfur (i.e., the MMC is an MMS), selenium, or tellurium. In some embodiments, the chalcogen in an MMC is not sulfur. Corresponding MMCs that do not use sulfur as the chalcogen are contemplated for each of the examples of MMSes in the foregoing paragraphs.

Furthermore, it is found that use of such a blend of two or more intercalation materials (e.g., including one or more chalcogenides) results in improved PS behavior, resulting in better battery performance, such as prolonged battery lifespan, improved volumetric and coulombic efficiency, and improved cyclability with negligible or reduced capacity fading. Attempts have been made to manage PS behavior (e.g., dissolution, diffusion, shuttling, and anodic corrosion) in lithium sulfur batteries via cathode and electrolyte formulations and designs. These include techniques that attempt to inhibit deleterious formation and/or dissolution of PS (PS-bypass), as well as techniques that attempt to beneficially retain PS in the Li—S system (PS-retain). Without wishing to be confined to any particular theory, it is postulated that use of a blend of intercalation materials (e.g., including one or more chalcogenides) with discharge voltage profile similar to S₈→Li₂S, as described herein, achieves a balance between a PS-bypass and a PS-retain strategy for cathode formulation and design that cannot be realized by other techniques. For example, use of the blend of intercalation materials may inhibit the PS shuttling effect, thereby minimizing its deleterious impact on battery operation. Moreover, use of the blend of intercalation materials described herein may reduce undesired generation and/or dissolution of long-chain PS anions. Furthermore, use of the blend of intercalation materials in a sulfur and/or lithium sulfide cathode presented herein may allow for higher sulfur loading and lower electrolyte-to-sulfur (E/S) ratio as compared to other PS-management techniques, thereby contributing to improved energy density of the lithium sulfur battery.

In some embodiments, a lithium-sulfur battery of the present disclosure comprises a lithium anode, a sulfur-based cathode [e.g., comprising a sulfur electroactive material and two or more non-sulfur electroactive materials (e.g., a blend of the two or more non-sulfur electroactive materials)], and an electrolyte permitting ion transport between anode and cathode. In certain embodiments, described herein, an anodic portion of a battery comprises an anode and a portion of electrolyte with which it is in contact. Similarly, in certain embodiments, described herein, a cathodic portion of a battery comprises a cathode and a portion of electrolyte with which it is in contact. In certain embodiments, a battery comprises a lithium ion-permeable separator, which defines a boundary between an anodic portion and a cathodic portion. In certain embodiments, a battery comprises a case, which encloses both anodic and cathodic portions. In certain embodiments, a battery case comprises an electrically conductive anodic-end cover in electrical communication with an anode, and an electrically conductive cathodic-end cover in electrical communication with a cathode to facilitate charging and discharging via an external circuit.

### Cathode

Compositions of the present disclosure have utility in manufacture of electrochemical devices. They may be porous or non-porous. Certain compositions disclosed herein would be adhered to a current collector to form cathodes for secondary sulfur batteries. Provided cathode compositions may comprise one or more additives such as electrically conductive particles, binders, and other functional additives typically found in battery cathode mixtures. Generally, provided compositions include plentiful conductive particles to increase electrical conductivity of a cathode and provide a low resistance pathway for electrons to access such manufactured cathode. In various embodiments, other additives are included in the composition to alter or otherwise enhance a cathode produced according to the principles described herein. Other cathode components include, for example, a current collector, connecting tabs, and the like.

As discussed above, in certain embodiments, the cathode composition includes a blend of two or more intercalation materials in sulfur (e.g., sulfur in its S₈ cyclic octatomic molecular form) and/or lithium sulfide (e.g., Li₂S₂ and/or Li₂S). In certain embodiments, the blend of intercalation materials comprises two or more intercalation materials each having a discharge voltage plateau distinct from each other such that the blend has a discharge voltage profile with two or more plateaus. In certain embodiments, the blend of two or more intercalation materials is chosen such that its discharge voltage profile—considered apart from the sulfur and/or lithium sulfide—has voltage plateaus that approximate those of the discharge voltage profile of S₈→Li₂S.

In certain embodiments, the blend of two or more intercalation materials comprises one or more chalcogenides (e.g., wherein each of the two or more intercalation materials is a chalcogenide). In certain embodiments, a chalcogenide has at least one chalcogen anion (oxygen, sulfur, selenium, tellurium, or polonium anion) and at least one electropositive element. In certain embodiments, the one or more chalcogenides may be sulfide-, selenide-, or telluride-based. In certain embodiments, the one or more chalcogenides comprises a metal sulfide. In certain embodiments, the one or more chalcogenides comprises one or more of the following: TiS₂, TiS₃, LiTiS₂ (LTS), and NbSe₃. In certain embodiments, the one or more chalcogenides comprises a transition metal oxide and/or a polyanion compound. In certain embodiments, the one or more chalcogenides comprises a metal monochalcogenide having the formula MX where M is a transition metal and X is S, Se, or Te. In certain embodiments, the one or more chalcogenides comprises at least one transition metal dichalcogenide (TMD) of the formula MX₂, where M is a transition metal (e.g., Ti, V, Co, Ni, Zr, Nb, Mo, Tc, Rh, Pd, Hf, Ta, W, Re, Ir, or Pt) and where X is S, Se, or Te. In certain embodiments, the one or more chalcogenides comprises a material with a layered crystal structure (e.g., LiTiS₂, LiCoO₂, LiNiO₂, LiMnO₂, LiNi_{0.33}Mn_{0.33}Co_{0.33}O₂, LiNi_{0.8}Co_{0.15}Al_{0.05}O₂, or Li₂MnO₃), a material with a spinel crystal structure (e.g., LiMn₂O₄ or LiCo₂O₄), a material with an olivine crystal structure (e.g., LiFePO₄, LiMnPO₄, or LiCoPO₄), and/or a material with a tavorite crystal structure (e.g., LiFeSO₄F or LiVPO₄F).

In some embodiments, a non-sulfur electroactive material comprises particles (e.g., nanoparticles). For example, chalcogenide particles may be used as a non-sulfur electroactive material. A blend of two or more non-sulfur electroactive materials may include a blend of two types of particles (e.g., two different chalcogenides), particles that include a blend of two non-sulfur electroactive materials (e.g., particles comprising two different chalcogenides), or both. In some embodiments, non-sulfur electroactive material particles are distributed (e.g., dispersed) throughout a cathode material. A cathode material may include particles that comprise sulfur electroactive material (e.g., particles of sulfur electroactive material). One or more non-sulfur electroactive materials may form one or more discrete and/or one or more interconnected (e.g., charge and/or ion) transport pathways through a cathode material (e.g., in a cathode of a battery). One or more non-sulfur electroactive materials may be distributed (e.g., dispersed) throughout a sulfur electroactive material matrix (e.g., comprising one or more than one sulfur electroactive material). As described elsewhere, at least one non-sulfur electroactive material of a blend may be included in a shell of a core shell particle that includes a core of a sulfur electroactive material. Particles (e.g., nanoparticles) may have any suitable shape, such as, for example, rods, flakes, tubes, spheres. Particles may be porous or non-porous. Particles may have any suitable size. In some embodiments, particles have no dimension larger than 500 micrometers, than 250 micrometers, than 100 micrometers, than 50 micrometers, than 20 micrometers, than 10 micrometers, than 5 micrometers, than 1 micrometer, than 500 nanometers, than 400 nanometers, than 300 nanometers, than 250 nanometers, than 200 nanometers, than 100 nanometers, or than 50 nanometers.

In certain embodiments, the cathode composition contains conductive materials and a binder. In certain embodiments, a conductive material comprises an electrically conductive material that facilitates movement of electrons within a composite. For example, in certain embodiments, a conductive material is selected from the group consisting of carbon-based materials, graphite-based materials, conductive polymers, metals, semiconductors, metal oxides, metal sulfides, and combinations thereof. In certain embodiments, a conductive material comprises a carbon-based material. For example, in certain embodiments, provided cathode compositions may comprise 3D structured graphene (e.g., as described in U.S. Pat. No. 11,299,397, LytEn, Inc., the text of which is incorporated herein by reference in its entirety). In certain embodiments, a conductive material comprises a graphite-based material. In certain embodiments, the cathode composition does not contain carbon, or contains a low amount of carbon (e.g., no greater than 5.0 wt. %, no greater than 3.0 wt. %, no greater than 2.0 wt. %, no greater than 1.0 wt. %, or no greater than 0.5 wt. %).

In certain embodiments, an electrically conductive material is selected from the group consisting of conductive carbon powders, such as carbon black, Super P®, C-NERGY™ Super C65, Ensaco® black, Ketjenblack®, acetylene black, synthetic graphite such as Timrex® SFG-6, Timrex® SFG-15, Timrex® SFG-44, Timrex® KS-6, Timrex® KS-15, Timrex® KS-44, natural flake graphite, carbon nanotubes, fullerenes, hard carbon, mesocarbon microbeads, and the like. In certain embodiments, a conductive material comprises one or more conductive polymers. For example, in certain embodiments, a conductive polymer is selected from the group consisting of polyaniline, polythiophene, polyacetylene, polypyrrole, and the like. In some embodiments, a conductive polymer is a cationic polymer. In some embodiments, a cationic polymer is a quaternary ammonium polymer. In certain embodiments, a cationic polymer is selected from the group consisting of a polydiallyldimethylammonium salt, a poly[(3-chloro-2-hydroxypropyl)methacryloxyethyldimethyl-ammonium salt, a poly(butyl acrylate-methacryloxyethyltrimethylammonium) salt, poly(1-methyl-4-vinylpyridinium) salt, a poly(1-methyl-2-vinylpyridinium) salt, and a poly(methyacryloxyethyltriethylammonium) salt. In certain embodiments, a cationic polymer is selected from polydiallyldimethylammonium chloride (polyDADMAC), polybrene, epichlorohydrin-dimethylamine (epi-DMA), poly[(3-chloro-2-hydroxypropyl)methacryloxyethyldimethyl-ammonium chloride), poly(acrylamide-methacryloxyethyltrimethylammonium bromide), poly(butyl acrylate-methacryloxyethyltrimethylammonium bromide), poly(1-methyl-4-vinylpyridinium bromide), poly(1-methyl-2-vinylpyridinium bromide), and poly(methyacryloxyethyltriethylammonium bromide). In certain embodiments, a conductive material comprises one or more metal oxides or sulfides. For example, in certain embodiments, a conductive material comprises one or more oxides or sulfides of a first-row transition metal such as titanium, vanadium, chromium, manganese, iron, cobalt, copper, zinc, or combinations thereof. For example, in certain embodiments, a conductive material comprises one or more oxides or sulfides of a second-row transition metal such as zirconium, indium, tin, antimony, or combinations thereof. In certain embodiments, a conductive material is used alone. In other embodiments, a conductive material is used as a mixture of two or more conductive materials described above.

In certain embodiments, a binder is included in the provided cathode composition materials. Binders are generally polymeric materials that help adhere individual particles composing a cathode mixture into a stable composite. Representative binders include polyvinylidene fluoride, poly(vinylidene fluoride-co-hexafluoropropene) (PVDF/HFP), polytetrafluoroethylene (PTFE), Kynar Flex® 2801, Kynar® Powerflex LBG, Kynar® HSV 900, Teflon®, carboxymethylcellulose, styrene-butadiene rubber (SBR), polyethylene oxide, polypropylene oxide, polyethylene, polypropylene, polyacrylates, polyvinyl pyrrolidone, poly(methyl methacrylate), polyethyl acrylate, polytetrafluoroethylene, polyvinyl chloride, polyacrylonitrile, polycaprolactam, polyethylene terephthalate, polybutadiene, polyisoprene or polyacrylic acid, or derivatives, mixtures, or copolymers of any of these. In some embodiments, a binder is water soluble binder, such as sodium alginate, carrageenan, or carboxymethyl cellulose. Generally, binders hold active materials together and in contact with a current collector (e.g., a metal foil such as aluminum, stainless steel, or copper, or a conductive carbon sheet). In certain embodiments, a binder is selected from the group consisting of poly(vinyl acetate), polyvinyl alcohol, polyethylene oxide, polyvinyl pyrrolidone, alkylated polyethylene oxide, crosslinked polyethylene oxide, polyvinyl ether, poly(methyl methacrylate), polyvinylidene fluoride, a copolymer of polyhexafluoropropylene and polyvinylidene fluoride, polyethyl acrylate, polytetrafluoroethylene, polyvinyl chloride, polyacrylonitrile, polyvinyl pyridine, polystyrene, and derivatives, mixtures, and copolymers thereof. In some embodiments, a binder is a cationic polymer. In some embodiments, a binder is a quaternary ammonium polymer. In some embodiments, a binder is a cationic polymer as described above.

In certain embodiments, a cathode further comprises a coating layer. For example, in certain embodiments, a coating layer comprises a polymer, an organic material, an inorganic material, or a mixture thereof that is not an integral part of the porous composite or the current collector. In certain such embodiments, a polymer is selected from the group consisting of polyvinylidene fluoride, a copolymer of polyvinylidene fluoride and hexafluoropropylene, poly(vinyl acetate), poly(vinyl butyral-co-vinyl alcohol-co-vinyl acetate), poly(methylmethacrylate-coethyl acrylate), polyacrylonitrile, polyvinyl chloride-co-vinyl acetate, polyvinyl alcohol, poly(l-vinylpyrrolidone-covinyl acetate), cellulose acetate, polyvinyl pyrrolidone, polyacrylate, polymethacrylate, polyolefin, polyurethane, polyvinyl ether, acrylonitrile-butadiene rubber, styrenebutadiene rubber, acrylonitrile-butadiene styrene, a sulfonated styrene/ethylene-butylene/styrene triblock copolymer, polyethylene oxide, and derivatives, mixtures, and copolymers thereof. In some embodiments, a coating layer comprises a cationic polymer. In some embodiments, a coating layer comprises a quaternary ammonium polymer. In some embodiments, a coating layer comprises a cationic polymer as described above. In certain such embodiments, an inorganic material comprises, for example, colloidal silica, amorphous silica, surface-treated silica, colloidal alumina, amorphous alumina, tin oxide, titanium oxide, titanium sulfide (TiS₂), vanadium oxide, zirconium oxide (ZrO₂), iron oxide, iron sulfide (FeS), iron titanate (FeTiO₃), barium titanate (BaTiO₃), and combinations thereof. In certain embodiments, an organic material comprises conductive carbon.

Suitable materials for use in cathode mixtures are disclosed in Cathode Materials for Lithium Sulfur Batteries: Design, Synthesis, and Electrochemical Performance, Lianfeng, et al., Interchopen.com, Published Jun. 1, 2016, and The strategies of advanced cathode composites for lithium-sulfur batteries, Zhou et al., SCIENCE CHINA Technological Sciences, Volume 60, Issue 2: 175-185(2017), the entire disclosures of each of which are hereby incorporated by reference herein.

In certain embodiments, the cathode comprises one or more of the following features: (a) a “stack” of multi-functional materials (e.g., wherein the stack comprises, for example, particles with gradient structures that balance the transport of ions and electrons for improved power capability, energy density, and life; bi-functional cathode additives that simultaneously store Li and conduct electrons, replacing expensive and space-wasting carbons; a binding molecule that spatially constrains the electrochemical reaction storing the energy and thereby extends life; electrolyte components that improve the basic efficiency of the electrolyte, providing improved energy density; and/or a cathode design that enables greater safety and energy density); (b) a tight electrode layer; (c) a tight tertiary structure; (d) porosity control; (e) a core-shell structure; (f) a cross-linked polymer shell; (g) a self-doped polymer shell; (h) an ion conductive binder; (i) a dual layer hybrid cathode; (j) a polymer that traps polysulfide; (k) a three-dimensional structure with high surface area (e.g., to hold both carbon and lithium, e.g., to intercalate); and (l) a three-dimensional structure within which carbon is replaced with a metal disulfide (e.g., and wherein the battery comprises a polymer electrolyte for sulfur).

### Anode

In certain embodiments, a secondary sulfur battery comprises a lithium anode. Any lithium anode suitable for use in lithium-sulfur cells may be used. In certain embodiments, an anode of a secondary sulfur battery comprises a negative active material selected from materials in which lithium intercalation reversibly occurs, materials that react with lithium ions to form a lithium-containing compound, metallic lithium, lithium alloys, and combinations thereof. In certain embodiments, an anode comprises metallic lithium. In certain embodiments, lithium-containing anodic compositions comprise carbon-based compounds. In certain embodiments, a carbon-based compound is selected from the group consisting of crystalline carbon, amorphous carbon, graphite, and mixtures thereof. In certain embodiments, the anode does not contain carbon, or contains a low amount of carbon (e.g., no greater than 5.0 wt. %, no greater than 3.0 wt. %, no greater than 2.0 wt. %, no greater than 1.0 wt. %, or no greater than 0.5 wt. %). In certain embodiments, a material that reacts with lithium ions to form a lithium-containing compound is selected from the group consisting of tin oxide (SnO₂), titanium nitrate, and silicon. In certain embodiments, a lithium alloy comprises an alloy of lithium with another alkali metal (e.g., sodium, potassium, rubidium or cesium). In certain embodiments, a lithium alloy comprises an alloy of lithium with a transition metal. In certain embodiments, lithium alloys include alloys of lithium and a metal selected from the group consisting of Na, K, Rb, Cs, Fr, Be, Mg, Ca, Sr, Ba, Ra, Al, Sn, In, Zn, Sm, La, and combinations thereof. In certain embodiments, a lithium alloy comprises an alloy of lithium with indium. In certain embodiments, a lithium alloy comprises an alloy of lithium with aluminum. In certain embodiments, a lithium alloy comprises an alloy of lithium with zinc. In certain embodiments, an anode comprises a lithium-silicon alloy. Examples of suitable lithium-silicon alloys include: Li₁₅Si₄, Li₁₂Si₇, Li₁₃Si₃, Li₁₃Si₄, and Li₂₁Si₅/Li₂₂Si₅. In certain embodiments, a lithium metal or lithium alloy is present as a composite with another material. In certain embodiments, such composites include materials such as graphite, graphene, metal sulfides or oxides, or conductive polymers.

In some embodiments, an anode is protected against redox shuttling reactions and hazardous runaway reactions by any of the methodologies reported in the art, for example, by creating a protective layer on a surface of an anode by chemical passivation or by deposition or polymerization. For example, in certain embodiments, an anode comprises an inorganic protective layer, an organic protective layer, or a mixture thereof, on a surface of lithium metal. In certain embodiments, an inorganic protective layer comprises Mg, Al, B, Sn, Pb, Cd, Si, In, Ga, lithium silicate, lithium borate, lithium phosphate, lithium phosphoronitride, lithium silicosulfide, lithium borosulfide, lithium aluminosulfide, lithium phosphosulfide, lithium fluoride or combinations thereof. In certain embodiments, an organic protective layer includes a conductive monomer, oligomer, or polymer. In certain embodiments, such polymer is selected from poly(p-phenylene), polyacetylene, poly(p-phenylene vinylene), polyaniline, polypyrrole, polythiophene, poly(2,5-ethylene vinylene), acetylene, poly(perinaphthalene), polyacene, and poly(naphthalene-2,6-di-yl), or combinations thereof.

Moreover, in certain embodiments, inactive sulfur material, generated from an electroactive sulfur material of a cathode, during charging and discharging of a secondary sulfur battery, attaches to an anode surface. The term “inactive sulfur”, as used herein, refers to sulfur that has no activity upon repeated electrochemical and chemical reactions, such that it cannot participate in an electrochemical reaction of a cathode. In certain embodiments, inactive sulfur on an anode surface acts as a protective layer on such electrode. In certain embodiments, inactive sulfur is lithium sulfide.

In some embodiments, a battery is a primary or low-cycle life battery. Such a battery may include an anode, a cathode (e.g., including a cathode material disclosed herein), an electrolyte, and optionally a separator. The cathode may be suitable for use in a secondary battery. Nonetheless, the battery may be a primary battery or a low-cycle life battery because, for example, the anode irreversibly degrades during discharge (e.g., over one or a small number of cycles).

It is further contemplated that the present disclosure can be adapted for use in sodium-sulfur batteries. Such sodium-sulfur batteries comprise a sodium-based anode, and are encompassed within the scope of the present disclosure.

It is further contemplated that the present disclosure can be adapted for use in batteries with an anode-free configuration. In certain embodiments, the battery has an anode-free configuration and comprises one or more of the following: (a) a thin layer of garnet, (b) a structure (e.g., a complex 3D structure) with a coating deposited by atomic layer deposition (ALD) (e.g., wherein the ALD coating comprises one or more members selected from the group consisting of lithium phosphorus oxynitride (LiPON), garnet, an oxide, perovskite, a sulphide, Li₃BO₃—Li₂CO₃ (LBCO), a sodium super ionic conductor (NASICON), and alumina); (c) a polymer (e.g., polyethylene oxide (PEO) or a block copolymer); (d) lithium phosphorus oxynitride (LiPON), and (e) a solid-electrolyte interface (SEI) layer (e.g., an artificial SEI layer formed in situ).

### Preparation of Electrodes

There are a variety of methods for manufacturing electrodes for use in a secondary sulfur battery. One process, such as a “wet process,” involves adding the solid cathode materials to a liquid to prepare a slurry composition. These slurries are typically in the form of a viscous liquid that is formulated to facilitate a downstream coating operation. A thorough mixing of a slurry can be important for coating and drying operations, which affect performance and quality of an electrode. Suitable mixing devices include ball mills, magnetic stirrers, sonication, planetary mixers, high speed mixers, homogenizers, universal type mixers, and static mixers. A liquid used to make a slurry can be one that homogeneously disperses an active material, a binder, a conducting material, and any additives, and that is easily evaporated. Suitable slurry liquids include, for example, N-methylpyrrolidone, acetonitrile, methanol, ethanol, propanol, butanol, tetrahydrofuran, water, isopropyl alcohol, dimethylpyrrolidone, propylene carbonate, gamma butyrolactone and the like.

In some embodiments, a prepared composition is coated on a current collector and dried to form an electrode. Specifically, a slurry is used to coat an electrical conductor to form an electrode by evenly spreading a slurry on to a conductor, which is then, in certain embodiments, optionally roll-pressed (e.g., calendared) and heated as is known in the art. Generally, a matrix of an active material and conductive material are held together and on a conductor by a binder. In certain embodiments, a matrix comprises a polymer binder, such as polyvinylidene fluoride (PVDF), poly(vinylidene fluoride-co-hexafluoropropene) (PVDF/HFP), polytetrafluoroethylene (PTFE), Kynar Flex® 2801, Kynar® Powerflex LBG, Kynar® HSV 900, Teflon®, styrene butadiene rubber (SBR), polyethylene oxide (PEO), or polytetrafluoroethylene (PTFE). In certain embodiments, additional carbon particles, carbon nanofibers, carbon nanotubes, are dispersed in a matrix to improve electrical conductivity. Alternatively or additionally, in certain embodiments, lithium salts are dispersed in a matrix to improve lithium conductivity.

In certain embodiments, a current collector is selected from the group consisting of: aluminum foil, copper foil, nickel foil, stainless steel foil, titanium foil, zirconium foil, molybdenum foil, nickel foam, copper foam, carbon paper or carbon fiber sheets, polymer substrates coated with conductive metal, and/or combinations thereof.

PCT Publication Nos. WO2015/003184, WO2014/074150, and WO2013/040067, the entire disclosures of which are hereby incorporated by reference herein, describe various methods of fabricating electrodes and electrochemical cells.

### Separator

In certain embodiments, a secondary sulfur battery comprises a separator, which divides the anode and cathode and prevents direct electron conduction between them. In certain embodiments, the separator has a high lithium ion permeability. In certain embodiments, a separator is relatively less permeable to polysulfide ions dissolved in electrolyte. In certain such embodiments, a separator as a whole inhibits or restricts passage of electrolyte-soluble sulfides between anodic and cathodic portions of a battery. In certain embodiments, a separator of impermeable material is configured to allow lithium ion transport between anode and cathode of a battery during charging and discharging of a cell. In some such embodiments, a separator is porous. One or more electrolyte-permeable channels bypassing, or penetrating through apertures in, an impermeable face of a separator can be provided to allow sufficient lithium ion flux between anodic and cathodic portions of a battery.

It will be appreciated by a person skilled in the art that optimal dimensions of a separator must balance competing imperatives: maximum impedance to polysulfide migration while allowing sufficient lithium ion flux. Aside from this consideration, shape and orientation of a separator is not particularly limited, and depends in part on battery configuration. For example, in some embodiments, a separator is substantially circular in a coin-type cell, and substantially rectangular in a pouch-type cell. In some embodiments, a separator is substantially flat. However, it is not excluded that curved or other non-planar configurations may be used.

A separator may be of any suitable thickness. In order to maximize energy density of a battery, it is generally preferred that a separator is as thin and light as possible. However, a separator should be thick enough to provide sufficient mechanical robustness and to ensure suitable electrical separation of the electrodes. In certain embodiments, a separator has a thickness of from about 1 μm to about 200 μm, preferably from about 5 μm to about 100 μm, more preferably from about 10 μm to about 30 μm.

### Electrolyte

In certain embodiments, a secondary sulfur battery comprises an electrolyte comprising an electrolytic salt. Examples of electrolytic salts include, for example, lithium trifluoromethane sulfonimide, lithium triflate, lithium perchlorate, LiPF₆, LiBF₄, tetraalkylammonium salts (e.g., tetrabutylammonium tetrafluoroborate, TBABF₄), liquid state salts at room temperature (e.g., imidazolium salts, such as 1-ethyl-3-methylimidazolium bis-(perfluoroethyl sulfonyl) imide, EMIBeti), and the like.

In certain embodiments, an electrolyte comprises one or more alkali metal salts. In certain embodiments, such salts comprise lithium salts, such as LiCF₃SO₃, LiClO₄, LiNO₃, LiPF₆, LiBr, LiTDI, LiFSI, and LiTFSI, or combinations thereof. In certain embodiments, an electrolyte comprises ionic liquids, such as 1-ethyl-3-methylimidzaolium-TFSI, N-butyl-N-methyl-piperidinium-TFSI, N-methyl-n-butyl pyrrolidinium-TFSI, and N-methyl-N-propylpiperidinium-TFSI, or combinations thereof. In certain embodiments, an electrolyte comprises superionic conductors, such as sulfides, oxides, and phosphates, for example, phosphorous pentasulfide, or combinations thereof.

In certain embodiments, an electrolyte is a liquid. For example, in certain embodiments, an electrolyte comprises an organic solvent. In certain embodiments, an electrolyte comprises only one organic solvent. In some embodiments, an electrolyte comprises a mixture of two or more organic solvents. In certain embodiments, a mixture of organic solvents comprising one or more weak polar solvents, strong polar solvents, and lithium protecting solvents.

The term “weak polar solvent”, as used herein, is defined as a solvent that is capable of dissolving elemental sulfur and has a dielectric coefficient of less than 15. A weak polar solvent is selected from aryl compounds, bicyclic ethers, and acyclic carbonate compounds. Examples of weak polar solvents include xylene, dimethoxyethane, 2-methyltetrahydrofuran, diethyl carbonate, dimethyl carbonate, toluene, dimethyl ether, diethyl ether, diglyme, tetraglyme, and the like. The term “strong polar solvent”, as used herein, is defined as a solvent that is capable of dissolving lithium polysulfide and has a dielectric coefficient of more than 15. A strong polar solvent is selected from bicyclic carbonate compounds, sulfoxide compounds, lactone compounds, ketone compounds, ester compounds, sulfate compounds, and sulfite compounds. Examples of strong polar solvents include hexamethyl phosphoric triamide, γ-butyrolactone, acetonitrile, ethylene carbonate, propylene carbonate, N-methylpyrrolidone, 3-methyl-2-oxazolidone, dimethyl formamide, sulfolane, dimethyl acetamide, dimethyl sulfoxide, dimethyl sulfate, ethylene glycol diacetate, dimethyl sulfite, ethylene glycol sulfite, and the like. The term “lithium protection solvent”, as used herein, is defined as a solvent that forms a good protective layer, i.e. a stable solid-electrolyte interface (SEI) layer, on a lithium surface, and which shows a cyclic efficiency of at least 50%. A lithium protection solvent is selected from saturated ether compounds, unsaturated ether compounds, and heterocyclic compounds including one or more heteroatoms selected from the group consisting of N, O, and/or S. Examples of lithium protection solvents include tetrahydrofuran, 1,3-dioxolane, 3,5-dimethylisoxazole, 2,5-dimethyl furan, furan, 2-methyl furan, 1,4-oxane, 4-methyldioxolane, and the like.

In certain embodiments, an electrolyte is a liquid (e.g., an organic solvent). In some embodiments, a liquid is selected from the group consisting of organocarbonates, ethers, sulfones, water, alcohols, fluorocarbons, or combinations of any of these. In certain embodiments, an electrolyte comprises an ethereal solvent.

In certain embodiments, an organic solvent comprises an ether. In certain embodiments, an organic solvent is selected from the group consisting of 1,3-dioxolane, dimethoxyethane, diglyme, triglyme, γ-butyrolactone, γ-valerolactone, and combinations thereof. In certain embodiments, an organic solvent comprises a mixture of 1,3-dioxolane and dimethoxyethane. In certain embodiments, an organic solvent comprises a 1:1 v/v mixture of 1,3-dioxolane and dimethoxyethane. In certain embodiments, an organic solvent is selected from the group consisting of: diglyme, triglyme, γ-butyrolactone, γ-valerolactone, and combinations thereof. In certain embodiments, an electrolyte comprises sulfolane, sulfolene, dimethyl sulfone, methyl ethyl sulfone, or a combination thereof. In some embodiments, an electrolyte comprises ethylene carbonate, propylene carbonate, dimethyl carbonate, diethyl carbonate, methylethyl carbonate, or a combination thereof.

In certain embodiments, an electrolyte is a solid. In certain embodiments, a solid electrolyte comprises a polymer. In certain embodiments, a solid electrolyte comprises a glass, a ceramic, an inorganic composite, or combinations thereof. In certain embodiments, a solid electrolyte comprises a polymer composite with a glass, a ceramic, an inorganic composite, or combinations thereof. In certain embodiments, such solid electrolytes comprise one or more liquid components as plasticizers or to form a “gel electrolyte”.

### Secondary Sulfur Battery

Described herein are secondary sulfur batteries comprising cathode compositions described above. For example, in certain embodiments, such batteries include a lithium-containing anode composition coupled to the provided cathode composition by a lithium conducting electrolyte. In some embodiments, such batteries also comprise additional components such as separators between the anode and cathode, anodic and cathodic current collectors, terminals by which a cell can be coupled to an external load, and packaging such as a flexible pouch or a rigid metal container. It is further contemplated that the present disclosure regarding secondary sulfur batteries can be adapted for use in sodium-sulfur batteries, and such batteries are also considered within the scope of certain embodiments of the present disclosure.

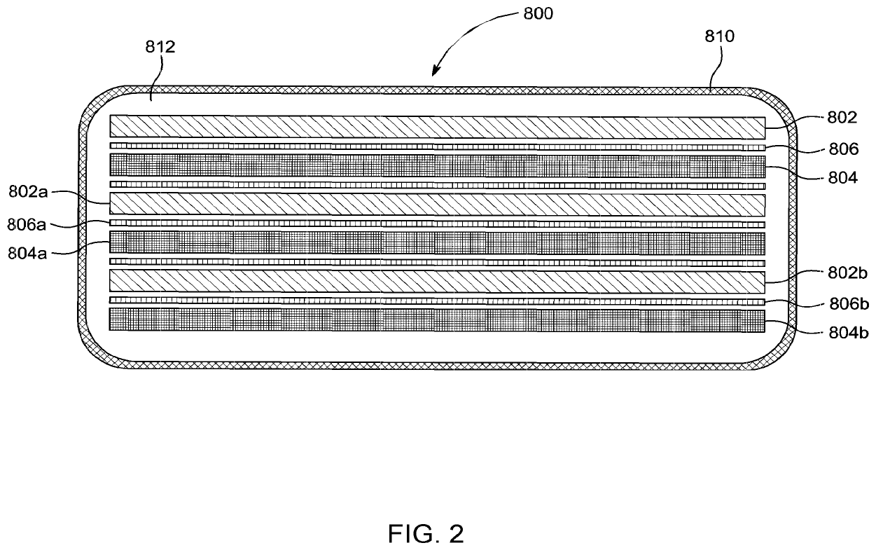

FIG. 2 illustrates a cross section of an electrochemical cell 800 in accordance with exemplary embodiments of the disclosure. Electrochemical cell 800 includes a negative electrode 802, a positive electrode 804, a separator 806 interposed between negative electrode 802 and positive electrode 804, a container 810, and a fluid electrolyte 812 in contact with negative and positive electrodes 802, 804. Such cells optionally include additional layers of electrode and separators 802a, 802b, 804a, 804b, 806a, and 806b.

Negative electrode 802 (also sometimes referred to herein as an anode) comprises a negative electrode active material that can accept cations. Non-limiting examples of negative electrode active materials for lithium-based electrochemical cells include Li metal, Li alloys such as those of Si, Sn, Bi, In, and/or Al alloys, Li₄Ti₅O₁₂, hard carbon, graphitic carbon, metal chalcogenides, and/or amorphous carbon. In accordance with some embodiments of the disclosure, most (e.g., greater than 90 wt %) of an anode active material can be initially included in a discharged positive electrode 804 (also sometimes referred to herein as a cathode) when electrochemical cell 800 is initially made, so that an electrode active material forms part of first electrode 802 during a first charge of electrochemical cell 800.

A technique for depositing electroactive material on a portion of negative electrode 802 is described in U.S. Patent Publication Nos. 2016/0172660 and 2016/0172661, in the name of Fischer et al., the contents of each of which are hereby incorporated herein by reference, to the extent such contents do not conflict with the present disclosure.

Positive electrode 804 (also referred to herein as cathode) comprises a cathode composition as described herein. In certain embodiments, the cathode composition comprises about 30 to about 70 wt % electroactive sulfur. In certain embodiments, a cathode comprises at least about 70% of total sulfur present in an electrochemical cell. In certain embodiments, a cathode comprises at least about 80% of total sulfur present in an electrochemical cell. In certain embodiments, a cathode comprises at least about 90% of total sulfur present in an electrochemical cell. In certain embodiments, a cathode comprises at least about 95% of total sulfur present in an electrochemical cell. In certain embodiments, a cathode comprises at least about 99% of total sulfur present in an electrochemical cell. In certain embodiments, a cathode comprises essentially all of the total sulfur present in an electrochemical cell.

Negative electrode 802 and positive electrode 804 can further include one or more electrically conductive additives as described herein. In accordance with some embodiments of the disclosure, negative electrode 802 and/or positive electrode 804 further include one or more polymer binders as described herein.

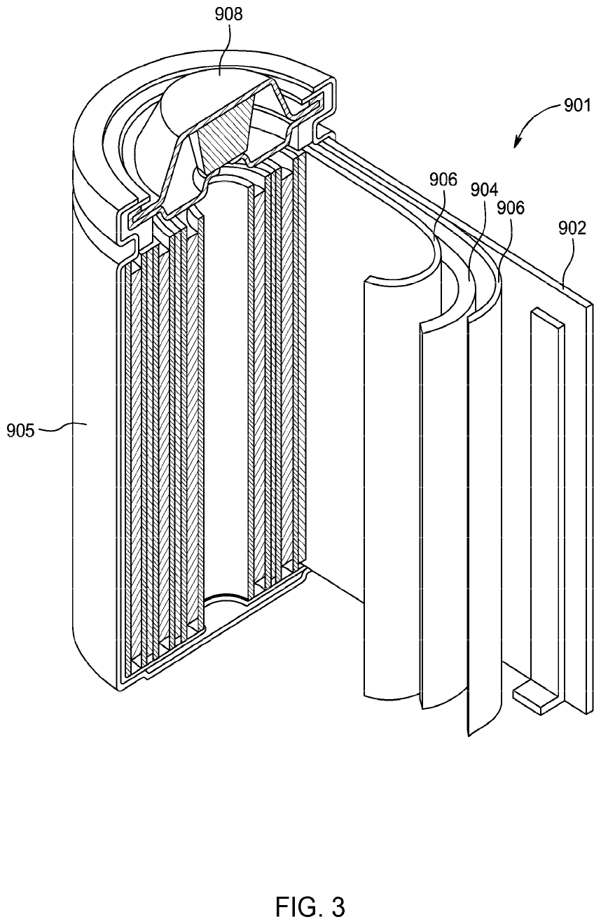

FIG. 3 illustrates an example of a battery according to various embodiments described herein. A cylindrical battery is shown here for illustration purposes, but other types of arrangements, including prismatic or pouch (laminate-type) batteries, may also be used as desired. Example Li battery 901 includes a negative anode 902, a positive cathode 904, a separator 906 interposed between the anode 902 and the cathode 904, an electrolyte (not shown) impregnating the separator 906, a battery case 905, and a sealing member 908 sealing the battery case 905. It will be appreciated that example battery 901 may simultaneously embody multiple aspects of the present disclosure in various designs.

A secondary sulfur battery of the present disclosure comprises a lithium anode, a porous sulfur-based cathode, and an electrolyte permitting lithium ion transport between anode and cathode. In certain embodiments, described herein, an anodic portion of a battery comprises an anode and a portion of electrolyte with which it is in contact. Similarly, in certain embodiments, described herein, a cathodic portion of a battery comprises a cathode and a portion of electrolyte with which it is in contact. In certain embodiments, a battery comprises a lithium ion-permeable separator, which defines a boundary between an anodic portion and a cathodic portion. In certain embodiments, a battery comprises a case, which encloses both anodic and cathodic portions. In certain embodiments, a battery case comprises an electrically conductive anodic-end cover in electrical communication with an anode, and an electrically conductive cathodic-end cover in electrical communication with a cathode to facilitate charging and discharging via an external circuit.

In certain embodiments, a secondary sulfur battery of the present disclosure is defined in terms of its ratio of electrolyte to electroactive sulfur. Electrolyte volume and the ratio (vol/wt) of electrolyte to sulfur in a cathode correlate to energy density of a sulfur battery. Electrolyte may be distributed among different volumes within a cell, for example electrolyte may be contained in porosity of the cathode, in the separator, and in contact with the anode or within an anodic solid electrolyte interphase. Electrolyte may also be contained in other spaces within a battery where it is not in direct contact with the anodic or cathodic active materials—for example electrolyte may be stranded in an annular volume at the edges of a coin cell. In certain embodiments, the present disclosure provides batteries where all or most of the electrolyte is contained within the cathode. Preferably, substantially all of the electrolyte is contained within the cathode and only a minimal amount of electrolyte that is necessary to wet the separator and the anode surface or SEI is outside of the cathode. Electrolyte contained within the cathode is referred to as “contained electrolyte” and its volume V_{CE} can be estimated as theoretical pore volume, or porosity multiplied by the geometric volume of a cathode film:

$${V}_{CE} = P \% \times Area \times {thickness}_{cathode}$$

In certain embodiments, a provided secondary sulfur battery is characterized in that at least 50% of the total electrolyte inventory (Vₜₒₜ) is contained in the cathode (e.g., V_{CE}/Vₜₒₜ>0.5). In certain embodiments, a provided secondary sulfur battery is characterized in that at least 50% of the total electrolyte inventory (Vₜₒₜ) is contained in the cathode (e.g., V_{CE}/Vₜₒₜ>0.8). In certain embodiments, a secondary sulfur battery has at least 60%, at least 65%, or at least 70% of the electrolyte contained in the cathode porosity. In certain embodiments, a secondary sulfur battery has at least 80%, at least 85%, or at least 90%, of the electrolyte contained in the cathode porosity. In certain embodiments, a secondary sulfur battery has at least 92%, at least 94%, at least 95%, at least 96%, or at least 97% of the electrolyte contained in the cathode.

The ratio of total electrolyte-to-sulfur (E/S) is another parameter that influences the energy density of a battery. The E/S ratio is calculated based on the total volume of electrolyte Vₜₒₜ and the mass of electroactive sulfur (m_{sulfur}):

$$\frac{E}{S} = \frac{{V}_{tot}}{{m}_{sulfur}}$$

In certain embodiments, a secondary sulfur battery has an electrolyte-to-sulfur ratio equal to or less than about 6 microliters of electrolyte per milligram of electroactive sulfur. In certain embodiments, a secondary sulfur battery has an electrolyte-to-sulfur ratio equal to or less than about 5 microliters of electrolyte per milligram of electroactive sulfur. In certain embodiments, a secondary sulfur battery has an electrolyte-to-sulfur ratio equal to or less than about 4.5 microliters of electrolyte per milligram of electroactive sulfur. In certain embodiments, a secondary sulfur battery has an electrolyte-to-sulfur ratio equal to or less than about 3.5 microliters of electrolyte per milligram of electroactive sulfur or less than about 3.0 microliters of electrolyte per milligram of electroactive sulfur. In certain embodiments, a secondary sulfur battery has an electrolyte-to-sulfur ratio equal to or less than about 3.5 microliters of electrolyte per milligram of electroactive sulfur. In certain embodiments, a secondary sulfur battery has an electrolyte-to-sulfur ratio equal to or less than about 3 microliters of electrolyte per milligram of electroactive sulfur. In certain embodiments, a secondary sulfur battery has an electrolyte-to-sulfur ratio between about 1.8 and about 3.5 μL/mg S. In certain embodiments, a secondary sulfur battery has an electrolyte-to-sulfur ratio between about 1.8 and about 2.5 μL/mg S.

### Core Shell Nanostructures

In certain embodiments, the cathode material has a core-shell structure (e.g., nanostructure), where the cores contain the sulfur active material and where their surrounding shells contain the non-sulfur electroactive material. In certain embodiments, the structures are nanoporous. In certain embodiments, the cores are have an average diameter less than about 1000 nm, less than about 500 nm, less than about 250 nm, less than about 100 nm, less than about 80 nm, less than about 70 nm, less than about 60 nm, less than about 50 nm, less than about 40 nm, less than about 30 nm, less than about 25 nm, less than about 20 nm, less than about 10 nm, or less than about 5 nm, for example, and/or the cores may have an average diameter within any range between any two of the above listed values. In certain embodiments, the cores are spherical, roughly spherical, or amorphous in shape. In certain embodiments, the cores are have an average diameter between about 50 and about 500 nm, between about 50 and about 200 nm, between about 20 and about 100 nm, between about 100 and about 300 nm, or between about 200 and about 400 nm.

In certain embodiments, the shells surrounding the cores have an average thickness less than about 1000 nm, less than about 500 nm, less than about 250 nm, less than about 100 nm, less than about 80 nm, less than about 70 nm, less than about 60 nm, less than about 50 nm, less than about 40 nm, less than about 30 nm, less than about 25 nm, less than about 20 nm, less than about 15 nm, less than about 10 nm, less than about 5 nm, less than about 3 nm, less than about 2 nm, or less than about 1 nm, for example. and/or the shells may have an average thickness within any range between any two of the above-listed values. In certain embodiments, the shells surrounding the cores have an average thickness between about 1 and about 50 nm, between about 2 and about 20 nm, between about 1 and about 10 nm, between about 10 and about 20 nm, between about 5 and about 15 nm, or between about 1 and about 5 nm.

In certain embodiments, the cores of the provided core shell particles are composed of substantially pure electroactive sulfur material. In certain embodiments, the cores comprise a composite of the electroactive sulfur material and additional materials such as inorganic solids, metals, polymers, or other non-sulfur electroactive materials. Such composites may comprise a simple physical mixture of the materials or a more complex structured composite such as a porous scaffold infused with the sulfur electroactive material.

In certain embodiments, the non-sulfur electroactive shell of provided core shell particles is non-porous and/or substantially impermeable to liquids (e.g., electrolytes) and/or impermeable to sulfur or polysulfides (or to mixtures of electrolytes and polysulfides). Such an arrangement can be advantageous in that it allows electrons and lithium ions to access the electroactive sulfur core while preventing redistribution of the electroactive sulfur material in the cathode or battery.

In other embodiments, the non-sulfur electroactive shell of provided core shell particles is porous and/or permeable (e.g., permeable to liquid electrolytes or their components). In certain embodiments, such permeable shells may be advantageous to ensure electrolyte contact with the electroactive sulfur and/or to prevent physical strain from volume changes within the core from rupturing or otherwise damaging the shell. In certain embodiments such shells are nano-porous; for example having pores with diameters less than 1 nm; for example, less than 0.5 nm, less than 0.4 nm, or less than 0.3 nm, or less than 0.2 nm, and/or an average pore size within any range between any two of the above-listed values. In certain embodiments, the cores and/or the shells have average pore sizes less than 1 nm; for example, less than 0.9 nm, less than 0.8 nm, less than 0.7 nm, or less than 0.6 nm, and/or an average pore size within any range between any two of the above-listed values. In certain embodiments, the pore size is measured by microscopy (e.g., TEM, SEM, or AFM).

In certain embodiments, the electroactive sulfur material comprises sulfur in its S₈ cyclic octatomic molecular form, in the form of lithium sulfide (e.g., Li₂S₂ and/or Li₂S), in the form of an electroactive organosulfur compound, and/or in the form of an electroactive sulfur-containing polymer. In certain embodiments, the non-sulfur electroactive blend comprises one or more non-sulfur chalcogenides.

In certain embodiments, a chalcogenide has at least one chalcogen anion (oxygen, sulfur, selenium, tellurium, or polonium anion) and at least one electropositive element. In certain embodiments, the chalcogenide may be sulfide-, selenide-, or telluride-based. In certain embodiments, the chalcogenide comprises a metal sulfide (for example a sulfide of a metal other than lithium or sodium). In certain embodiments, the one or more chalcogenides comprises a transition metal sulfide. In certain embodiments, the one or more chalcogenides comprises one or more of the following: TiS₂, LiTiS₂ (LTS), VS₂, MoS₂, Mo₆S₈, and NbSe₃. In certain embodiments, the one or more chalcogenides comprises a transition metal oxide and/or a polyanion compound. In certain embodiments, the one or more chalcogenides comprises a metal monochalcogenide having the formula MX where M is a transition metal and X is S, Se, or Te. In certain embodiments, the one or more chalcogenides comprises at least one transition metal dichalcogenide (TMD) of the formula MX₂, where M is a transition metal (e.g., Ti, V, Co, Ni, Zr, Nb, Mo, Tc, Rh, Pd, Hf, Ta, W, Re, Ir, or Pt) and where X is S, Se, or Te. In certain embodiments, the one or more chalcogenides comprises a material with a layered crystal structure (e.g., LiTiS₂, LiCoO₂, LiNiO₂, LiMnO₂, LiNi_{0.33}Mn_{0.33}Co_{0.33}O₂, LiNi_{0.8}Co_{0.15}Al_{0.05}O₂, or Li₂MnO₃), and/or a material with a spinel crystal structure (e.g., LiMn₂O₄ or LiCo₂O₄). In certain embodiments, the cathode material comprises LiFePO₄, LiMnPO₄, or LiCoPO₄ (e.g., having an olivine crystal structure), and/or LiFeSO₄F or LiVPO₄F (e.g., having a tavorite crystal structure). Throughout the description, where articles, devices, and systems are described as having, including, or comprising specific components, or where processes and methods are described as having, including, or comprising specific steps, it is contemplated that, additionally, there are articles, devices, and systems according to certain embodiments of the present disclosure that consist essentially of, or consist of, the recited components, and that there are processes and methods according to certain embodiments of the present disclosure that consist essentially of, or consist of, the recited processing steps. “Sulfur electroactive material” and “electroactive sulfur material” are used interchangeably herein.

It should be understood that the order of steps or order for performing certain action is immaterial so long as operability is not lost. Moreover, two or more steps or actions may be conducted simultaneously. As is understood by those skilled in the art, the terms “over”, “under”, “above”, “below”, “beneath”, and “on” are relative terms and can be interchanged in reference to different orientations of the layers, elements, and substrates included in the present disclosure. For example, a first layer on a second layer, in some embodiments means a first layer directly on and in contact with a second layer. In other embodiments, a first layer on a second layer can include another layer there between.

Headers have been provided for the convenience of the reader—the presence and/or placement of a header is not intended to limit the scope of the subject matter described herein.

### EQUIVALENTS

It is contemplated that systems, devices, methods, and processes of the disclosure encompass variations and adaptations developed using information from the embodiments described herein. Adaptation and/or modification of the systems, devices, methods, and processes described herein may be performed by those of ordinary skill in the relevant art.

Certain embodiments of the present disclosure were described above. It is, however, expressly noted that the present disclosure is not limited to those embodiments, but rather the intention is that additions and modifications to what was expressly described in the present disclosure are also included within the scope of the disclosure. Moreover, it is to be understood that the features of the various embodiments described in the present disclosure were not mutually exclusive and can exist in various combinations and permutations, even if such combinations or permutations were not made express, without departing from the spirit and scope of the disclosure. The disclosure has been described in detail with particular reference to certain embodiments thereof, but it will be understood that variations and modifications can be effected within the spirit and scope of the claimed invention.

1. A cathode material comprising a mixture of:
a first active material comprising at least one electroactive sulfur material; and
a second non-sulfur active material comprising a blend of two or more non-sulfur electroactive materials (e.g., metal chalcogenides, transition metal oxides, and/or polyanion compounds), said blend selected such that a discharge voltage profile of the blend has voltage plateaus that approximate a discharge voltage profile of the at least one electroactive sulfur material [e.g., wherein the cathode material is at least 10 mass % non-sulfur electroactive material (e.g., metal chalcogenide) relative to sulfur (e.g., from 10 to 90 mass % non-sulfur electroactive material, e.g., from 30 to 70 mass % non-sulfur electroactive material)].

2. The cathode material of claim 1, wherein the voltage profiles of the first active material and the second active material are measured in isolation under similar electrochemical conditions to assess whether they approximate each other.

3. The cathode material of claim 1 or 2, wherein the blend of two or more non-sulfur electroactive materials have a discharge voltage profile characterized in that, for at least 50% of total discharge (e.g., for at least 60%, for at least 75%, or for at least 80% of total discharge), the discharge voltage attributable to the blended non-sulfur material is within 10% (e.g., within 5%, within 3%, or within 1%) of the sulfur discharge voltage attributable to the at least one electroactive sulfur material.

4. The cathode material of any one of the preceding claims, wherein the at least one electroactive sulfur material comprises at least one of (i) to (iv) as follows: (i) sulfur in its S₈ cyclic octatomic molecular form, (ii) sulfur in the form of lithium sulfide (e.g., Li₂S₂ and/or Li₂S), (iii) sulfur in the form of an electroactive organosulfur compound, and (iv) sulfur in the form of an electroactive sulfur-containing polymer.

5. The cathode material of any one of the preceding claims, wherein each of the two or more non-sulfur electroactive materials (e.g., intercalation materials) has an individual discharge voltage profile with a voltage plateau that is distinct from a voltage plateau of an individual discharge voltage profile of any other of the two or more non-sulfur electroactive materials.

6. The cathode material of any one of the preceding claims, wherein the blend of two or more non-sulfur electroactive materials comprises one or more chalcogenides (e.g., wherein each of the two or more non-sulfur electroactive materials is a chalcogenide) (e.g., comprising one or more metal chalcogenides, e.g., one or more metal sulfides).

7. The cathode material of claim 6, wherein each of the two or more non-sulfur electroactive materials (i) has a different crystal structure (e.g., layered, spinel, olivine, tavorite), (ii) has a different composition, or (iii) both (i) and (ii).

8. The cathode material of any one of the preceding claims, wherein the second non-sulfur active material has a discharge voltage profile with two plateaus.

9. The cathode material of claim 8, wherein one of the two plateaus corresponds to soluble/intermediate polysulfide conversion and another of the two plateaus corresponds to solid or quasi-solid product(s).

10. The cathode material of any one of the preceding claims, wherein the second non-sulfur active material has a discharge voltage profile that approximates a discharge voltage profile of sulfur to a lithium sulfide (e.g., S₈→Li₂S).

11. The cathode material of any one of claims 8 to 10, wherein the discharge voltage profile with two plateaus has a first plateau in a range from about 2.2 to about 2.4 (V vs. Li/Li⁺), and a second plateau in a range from about 2.0 to about 2.2 (V vs. Li/Li⁺).

12. A cathode material comprising:
an electroactive sulfur material [e.g., at least one of (i) to (iv) as follows: (i) sulfur in its S₈ cyclic octatomic molecular form, (ii) sulfur in the form of lithium sulfide (e.g., Li₂S₂ and/or Li₂S), (iii) sulfur in the form of an electroactive organosulfur compound, and (iv) sulfur in the form of an electroactive sulfur-containing polymer] [e.g., at least one of (i) sulfur (S₈) and (ii) a lithium sulfide (e.g., Li₂S₂ and/or Li₂S)]; and
two or more non-sulfur electroactive materials [e.g., intercalation materials (e.g., lithium-intercalation materials], wherein the two or more electroactive materials together have a discharge voltage profile with at least two distinct voltage plateaus.

13. The cathode material of claim 12, wherein the two or more non-sulfur electroactive materials together have a discharge voltage profile that corresponds to a discharge voltage profile for sulfur (e.g., each of the two or more electroactive materials having a discharge voltage profile with a voltage plateau that corresponds to a voltage plateau of the discharge voltage profile for sulfur).

14. The cathode material of claim 12 or 13, wherein each of the two or more non-sulfur electroactive materials has an individual discharge voltage profile with a voltage plateau that is distinct from a voltage plateau of an individual discharge voltage profile of any other of the two or more non-sulfur electroactive materials.

15. The cathode material of any one of claims 12 to 14, wherein the voltage plateau of the individual discharge voltage profile of each of the two or more electroactive materials is within 10% (e.g., within 5%, within 3%, or within 1%) of a corresponding voltage plateau of the discharge voltage profile for sulfur.

16. The cathode material of any one of the preceding claims, comprising core shell structures.

17. The cathode material of claim 16, the core shell structures comprising cores each having a surrounding shell, said cores comprising the electroactive sulfur material (e.g., S₈, Li₂S₂ and/or Li₂S), and said shells comprising at least one of the two or more non-sulfur electroactive materials (e.g., one or more metal chalcogenides).

18. The cathode material of claim 16 or 17, wherein the core shell structures have an average core diameter in a range from 50 to 300 nm, and an average shell thickness in a range from 1 to 20 nm thick (e.g., no greater than 10 nm thick).

19. The cathode material of any one of claims 16 to 18, wherein the core shell structures have at least 10 mass % non-sulfur electroactive material (e.g., metal chalcogenide) relative to sulfur (e.g., from 10 to 90 mass % non-sulfur, non-carbon electroactive material, e.g., from 30 to 70 mass % non-sulfur, non-carbon electroactive material).

20. A battery comprising (i) a cathode comprising the cathode material according to any one of the preceding claims and (ii) an electrolyte (e.g., a solid-state electrolyte (SSE)) in contact with the cathode.

21. The battery of claim 20, further comprising an anode.

22. The battery of claim 21, wherein the anode is a protected lithium metal anode.

23. The battery of claim 20, further comprising a protected current collector.

24. A method of operating a lithium sulfur battery comprising a cathode comprising (i) sulfur or a lithium sulfide (e.g., Li₂S₂ and/or Li₂S) (e.g., both sulfur and a lithium sulfide), (ii) a first non-sulfur electroactive material (e.g., first intercalation material), and (iii) a second non-sulfur electroactive material (e.g., a second intercalation material) different from the first non-sulfur electroactive material, the method comprising discharging the battery by:
simultaneously inserting (e.g., intercalating) lithium into the first non-sulfur electroactive material while at least partially converting at least a portion of the sulfur or a lithium sulfide (e.g., from S₈→Li₂S) at a first voltage; and
subsequently simultaneously inserting (e.g., intercalating) lithium into the second non-sulfur electroactive material while at least partially (e.g., further) converting at least a portion the sulfur of a lithium sulfide (e.g., from S₈→Li₂S) at a second voltage different from the first voltage.

25. The method of claim 24, comprising charging the battery after discharging the battery, wherein charging the battery comprises:
simultaneously (i) removing lithium from the first non-sulfur electroactive material, (ii) removing lithium from the second non-sulfur electroactive material, and (iii) at least partially converting at least a portion of the sulfur or a lithium sulfide (e.g., from Li₂S→S₈) at a third voltage (e.g., different from the first voltage and from the second voltage).

26. A method of operating a battery comprising a cathode comprising (i) a sulfur electroactive material, (ii) a first non-sulfur electroactive material (e.g., first intercalation material), and (iii) a second non-sulfur electroactive material (e.g., a second intercalation material) different from the first non-sulfur electroactive material, the method comprising discharging the battery by:
simultaneously inserting (e.g., intercalating) an ion (e.g., lithium) into the first non-sulfur electroactive material while at least partially converting at least a portion of the sulfur electroactive material at a first voltage; and
subsequently simultaneously inserting (e.g., intercalating) an ion (e.g., lithium) into the second non-sulfur electroactive material while at least partially (e.g., further) converting at least a portion the sulfur electroactive material [e.g., of a lithium sulfide (e.g., from S₈→Li₂S)] at a second voltage different from the first voltage.

27. The method of claim 26, comprising charging the battery after discharging the battery, wherein charging the battery comprises:
simultaneously (i) removing the ion from the first non-sulfur electroactive material, (ii) removing the from the second non-sulfur electroactive material, and (iii) at least partially converting at least a portion of the sulfur electroactive material [e.g., the sulfur or lithium sulfide (e.g., from Li₂S→S₈)] at a third voltage (e.g., different from the first voltage and from the second voltage).

28. A solid-state sulfur battery comprising:
an anode;
a solid electrolyte; and
a cathode comprising:
a first active material comprising at least one electroactive sulfur material; and
one or more non-sulfur electroactive materials (e.g., metal chalcogenides, transition metal oxides, and/or polyanion compounds), wherein a discharge voltage profile of the one or more non-sulfur electroactive materials approximates at least a portion of a discharge voltage profile of the at least one electroactive sulfur material [e.g., wherein the cathode material is at least 10 mass % non-sulfur electroactive material (e.g., metal chalcogenide) relative to sulfur (e.g., from 10 to 90 mass % non-sulfur electroactive material, e.g., from 30 to 70 mass % non-sulfur electroactive material)].

29. The battery of claim 28, wherein the one or more non-sulfur electroactive materials is a blend of two or more non-sulfur electroactive materials.

30. The battery of claim 29, wherein the at least a portion of the discharge voltage profile comprises two or more distinct portions, each corresponding to one of the two or more non-sulfur electroactive materials.

31. The battery of claim 28, wherein the one or more non-sulfur electroactive materials comprises (e.g., is) a mixed metal sulfide.

32. The battery of any one of claims 28-31, wherein the at least a portion of the discharge voltage profile exists in a voltage range of 2.5 V to 1.9 V (e.g., 2.3 V to 2.1 V) and/or a SoC range of 90% to 30% (e.g., 90% to 60%).

33. The battery of any one of claims 28-32, wherein the at least a portion of the discharge voltage profile is a sloping (e.g., moderately and/or monotonically sloping) portion of the discharge voltage profile.

34. A cathode material comprising a mixture of:
at least one electroactive sulfur material; and
at least one non-sulfur electroactive material that is a mixed metal chalcogenide, wherein a discharge voltage profile of the at least one non-sulfur electroactive material corresponds to a discharge voltage profile of the at least one electroactive sulfur material.

35. The cathode material of claim 34, wherein the at least one non-sulfur electroactive material comprises two non-sulfur electroactive materials (two mixed metal chalcogenides).

36. The cathode material of claim 34, wherein the at least one non-sulfur electroactive material is a single non-sulfur electroactive material (a single mixed metal chalcogenides).

37. The cathode material of any one of claims 34-36, wherein the mixed metal chalcogenide is a mixed metal sulfide (e.g., wherein the mixed metal chalcogenides are mixed metal sulfides where the at least one non-sulfur electroactive material comprises two non-sulfur electroactive materials).

38. The cathode material of any one of claims 34-37, wherein the discharge voltage profile of the at least one non-sulfur electroactive material has voltage plateaus that approximate voltage plateaus of the at least one electroactive sulfur material.

39. The cathode material of any one of claims 34-38, wherein the at least one non-sulfur electroactive material has a discharge voltage profile characterized in that, for at least 50% of total discharge (e.g., for at least 60%, for at least 75%, or for at least 80% of total discharge), the discharge voltage attributable to the at least one non-sulfur material is within 10% (e.g., within 5%, within 3%, or within 1%) of the sulfur discharge voltage attributable to the at least one electroactive sulfur material.

40. The cathode material of any one of claims 34-39, wherein the at least one electroactive sulfur material comprises at least one of (i) to (iv) as follows: (i) sulfur in its S₈ cyclic octatomic molecular form, (ii) sulfur in the form of lithium sulfide (e.g., Li₂S₂ and/or Li₂S), (iii) sulfur in the form of an electroactive organosulfur compound, and (iv) sulfur in the form of an electroactive sulfur-containing polymer.

41. The cathode material of any one of claims 34-40, wherein the discharge voltage profile of the at least one non-sulfur electroactive material has two voltage plateaus with one of the two plateaus corresponding to soluble/intermediate polysulfide conversion and another of the two plateaus corresponding to solid or quasi-solid product(s).

42. The cathode material of any one of claims 34-41, wherein the discharge voltage profile of the at least one non-sulfur electroactive material has two voltage plateaus with a first plateau in a range from about 2.2 to about 2.4 (V vs. Li/Li⁺), and a second plateau in a range from about 2.0 to about 2.2 (V vs. Li/Li⁺).

43. The cathode material of any one of claims 34-42, wherein the at least one non-sulfur electroactive material has a discharge voltage profile that approximates a discharge voltage profile of sulfur to a lithium sulfide (e.g., S₈→Li₂S).

44. The cathode material of any one of claims 34-43, wherein the cathode material is at least 10 mass % non-sulfur electroactive material (e.g., mixed metal chalcogenide) relative to sulfur (e.g., from 10 to 90 mass % non-sulfur electroactive material, e.g., from 30 to 70 mass % non-sulfur electroactive material).

45. A battery comprising (i) a cathode comprising the cathode material according to any one of claims 34-44 and (ii) an electrolyte (e.g., a solid-state electrolyte (SSE)) in contact with the cathode.

46. The battery of claim 45, further comprising an anode.

47. The battery of claim 46, wherein the anode is a protected lithium metal anode.

48. The battery of claim 45, further comprising a protected current collector.

49. A cathode comprising the cathode material of any one of claims 1-19 and 34-44 (e.g., and a binder and/or conductive carbon).
